(19) United States
(12) Patent Application Publication
(10) Pub. No.: US 2024/0049028 A1
(43) Pub. Date: Feb. 8, 2024

(54) TERMINAL DEVICE, NETWORK NODE, AND METHODS THEREIN FOR MEASUREMENT REPORTING

(71) Applicant: Telefonaktiebolaget LM Ericsson (PUBL), Stockholm (SE)

(72) Inventors: Min Wang, LULEÅ (SE); Zhang Zhang, BEIJING (CN); Antonino Orsino, KIRKKONUMMI (FI)

(21) Appl. No.: 18/258,845

(22) PCT Filed: Dec. 8, 2021
(86) PCT No.: PCT/SE2021/051220

§ 371 Date: Jun. 22, 2023

(30) Foreign Application Priority Data
Dec. 22, 2020 (WO) PCT/CN2020/138309

(51) Int. Cl. H04W 24/10

(52) U.S. Cl. CPC H04W 24/10; H04W 88/04

(57) ABSTRACT

The present disclosure provides a method (800) in a first terminal device. The method (800) includes: obtaining (810) a first measurement result for a first link between the first terminal device and a second terminal device and/or a second measurement result for a second link between the first terminal device and a network node; and transmitting (820) the first measurement result and/or the second measurement result. The first measurement result and/or the second measurement result is obtained by measuring the first link and/or the second linkby the first terminal device, or receiving from the second terminal device the first measurement result and/or the second measurement result as obtained by measuring the first link and/or the second link by the second terminal device.

### TECHNICAL FIELD

The present disclosure relates to communication technology, and more particularly, to a terminal device, a network node, and methods therein for measurement reporting.

### BACKGROUND

Sidelink transmissions over New Radio (NR) are specified in the 3^{rd} Generation Partnership Project in Release 16, including enhancements of Proximity-based Services (ProSe) specified for Long Term Evolution (LTE). Four new enhancements are particularly introduced to NR sidelink transmissions as follows:
Support for unicast and groupcast transmissions is added in NR sidelink. For unicast and groupcast, a Physical Sidelink Feedback Channel (PSFCH) is introduced for a receiver User Equipment (UE) to reply a decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also leads to a new design of Physical Sidelink Common Control Channel (PSCCH).
To achieve a high connection density, congestion control and thus QoS management are supported in NR sidelink transmissions.

To enable the above enhancements, new physical channels and reference signals are introduced in NR:
Physical Sidelink Shared Channel (PSSCH), a sidelink version of Physical Downlink Shared Channel (PDSCH): The PSSCH is transmitted by a sidelink transmitter UE, and conveys sidelink transmission data, System Information Blocks (SIBs) for Radio Resource Control (RRC) configuration, and a part of Sidelink Control Information (SCI), a sidelink version of Downlink Control Information (DCI).
PSFCH, a sidelink version of Physical Uplink Control Channel (PUCCH): The PSFCH is transmitted by a sidelink receiver UE for unicast and groupcast, and conveys 1 bit information over 1 Resource Block (RB) for a Hybrid Automatic Repeat reQuest (HARQ) acknowledgement (ACK) or a negative ACK (NACK). In addition, Channel State Information (CSI) is carried in a Medium Access Control (MAC) Control Element (CE) over the PSSCH instead of the PSFCH.
PSCCH, a sidelink version of Physical Downlink Control Channel (PDCCH): When traffic to be sent to a receiver UE arrives at a transmitter UE, the transmitter UE should first send the PSCCH, which conveys a part of SCI to be decoded by any UE for the channel sensing purpose, including reserved time-frequency resources for transmissions, DeModulation Reference Signal (DMRS) pattern, and antenna port, etc.
Sidelink Primary/Secondary Synchronization Signal (S-PSS/S-SSS): Similar to downlink transmissions in NR, in sidelink transmissions, S-PSS and S-SSS are supported. Through detecting the S-PSS and S-SSS, a UE is able to identify a Sidelink Synchronization Identity (SSID) from the UE sending the S-PSS/S-SSS. The UE is therefore able to know the characteristics of the transmitter UE from the S-PSS/S-SSS. A series of processes of acquiring timing and frequency synchronization together with SSIDs of UEs is called initial cell search. Note that the UE sending the S-PSS/S-SSS may not be necessarily involved in sidelink transmissions, and a node (e.g., UE, evolved NodeB (eNB), or (next) generation NodeB (gNB)) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a Synchronization Signal/PSBCH Block (SSB). The SSB has the same numerology as PSCCH/PSSCH on the carrier, and an SSB should be transmitted within the bandwidth of the configured BWP. The PSBCH conveys information related to synchronization, such as the Direct Frame Number (DFN), an indication of the slot and symbol level time resources for sidelink transmissions, an in-coverage indicator, etc. The SSB is transmitted periodically at every 160 ms.
DMRS, Phase Tracking Reference Signal (PT-RS), Channel State Information Reference Signal (CSI-RS): These physical reference signals supported by NR downlink/uplink transmissions are also adopted by sidelink transmissions. Similarly, the PT-RS is only applicable for Frequency Range 2 (FR2) transmission.

Another new feature is the two-stage SCI. Unlike the DCI, only part (first stage) of the SCI is sent on the PSCCH. This part is used for channel sensing purposes (including reserved time-frequency resources for transmissions, DMRS pattern, and antenna port, etc.) and can be read by all UEs, while the remaining (second stage) scheduling and control information, such as a 8-bit source identity (ID) and a 16-bit destination ID, a New Data Indicator (NDI), a Redundancy Version (RV), and a HARQ process ID, is sent on the PSSCH to be decoded by the receiver UE.

As in ProSe in LTE, NR sidelink transmissions have the following two modes of resource allocations:
Mode 1: Sidelink resources are scheduled by a gNB.
Mode 2: The UE autonomously selects sidelink resources from one or more (pre)configured sidelink resource pools based on a channel sensing mechanism.

For an in-coverage UE, a gNB can be configured to adopt Mode 1 or Mode 2. For an out-of-coverage UE, only Mode 2 can be adopted.

In the 3GPP Technical Report (TR) 23.752 v0.3.0, which is incorporated here by reference in its entirety, a Layer 3 (L3) UE-to-Network relay is described (see clause 6.6).

FIG. 1 shows an architecture model using a ProSe 5G UE-to-Network Relay. The ProSe 5G UE-to-Network Relay entity provides the functionality to support connectivity to the network for Remote UEs. It can be used for both public safety services and commercial services (e.g. interactive services).

A UE is considered to be a Remote UE for a certain ProSe UE-to-Network Relay if it has successfully established a PC5 link to this ProSe 5G UE-to-Network Relay. A Remote UE can be located within Next Generation Radio Access Network (NG-RAN) coverage or outside of NG-RAN coverage.

The ProSe 5G UE-to-Network Relay shall relay unicast traffic (uplink and/or downlink) between the Remote UE and the network. The ProSe UE-to-Network Relay shall provide generic functions that can relay any IP traffic. One-to-one Direct Communication is used between Remote UEs and ProSe 5G UE-to-Network Relays for unicast traffic as specified in solutions for Key Issue #2 in the TR 23.752 v0.3.0. The protocol stack for L3 UE-to-Network Relay is shown in FIG. 2. For details of the protocol stack, reference can be made to TR 23.752 and description thereof will be omitted here.

Hop-by-hop security is supported in the PC5 link and Uu link. If there are requirements beyond hop-by-hop security for protection of Remote UE's traffic, security over IP layer needs to be applied. Further security details (integrity and privacy protection for remote UE-Network communication) will be specified in Service and System Aspects (SA) Work Group (WG) 3.

A ProSe 5G UE-to-Network Relay capable UE may register to the network (if not already registered) and establish a Protocol Data Unit (PDU) session enabling the necessary relay traffic, or it may need to connect to additional PDU session(s) or modify the existing PDU session in order to provide relay traffic towards Remote UE(s). PDU session(s) supporting UE-to-Network Relay shall only be used for Remote ProSe UE(s) relay traffic.

FIG. 3 shows a signaling sequence for ProSe 5G UE-to-Network Relay in TR 23.752. The sequence contains the following steps:
0. During the Registration procedure, Authorization and provisioning is performed for the ProSe UE-to-NW relay and Remote UE. Authorization and provisioning procedure may be any solution for key issue #1 and #3 in the TR 23.752 v0.3.
1. The ProSe 5G UE-to-Network Relay may establish a PDU session for relaying with default PDU session parameters received in step 0 or pre-configured in the UE-to-NW relay, e.g. Single Network Slice Selection Assistance Information (S-NSSAI), Data Network Name (DNN), Service and Session Continuity (SSC) mode. In case of Internet Protocol version 6 (IPv6), the ProSe UE-to-Network Relay obtains the IPv6 prefix via prefix delegation function from the network as defined in the 3GPP Technical Specification (TS) 23.501, v16.6.0.
2. Based on the Authorization and provisioning in step 0, the Remote UE performs discovery of a ProSe 5G UE-to-Network Relay using any solution for key issue #1 and #3 in the TR 23.752 v0.3.0. As part of the discovery procedure the Remote UE learns about the connectivity service the ProSe UE-to-Network Relay provides.
3. The Remote UE selects a ProSe 5G UE-to-Network Relay and establishes a connection for one-to-one ProSe Direct Communication as described in the 3GPP TS 23.287, v16.3.0.
If there is no PDU session satisfying the requirements of the PC5 connection with the remote UE, e.g. S-NSSAI, DNN, Quality of Service (QoS), the ProSe 5G UE-to-Network Relay initiates a new PDU session establishment or modification procedure for relaying.
4. IPv6 prefix or IPv4 address is allocated for the remote UE as it is defined in the 3GPP TS 23.303, v16.0.0, clauses 5.4.4.2 and 5.4.4.3. From this point the uplink and downlink relaying can start.
5. The ProSe 5G UE-to-Network Relay sends a Remote UE Report (Remote User ID, IP info) message to the SMF for the PDU session associated with the relay. The Remote User ID is an identity of the Remote UE user (provided via User Info) that was successfully connected in step 3. The Session Management Function (SMF) stores the Remote User IDs and the related IP info in the ProSe 5G UE-to-Network Relay's for the PDU connection associated with the relay.

For IP info the following principles apply:
for IPv4, the UE-to-network Relay shall report TCP/UDP port ranges assigned to individual Remote UE(s) (along with the Remote User ID);
for IPv6, the UE-to-network Relay shall report IPv6 prefix(es) assigned to individual Remote UE(s) (along with the Remote User ID).

The Remote UE Report message shall be sent when the Remote UE disconnects from the ProSe 5G UE-to-Network Relay (e.g. upon explicit layer-2 link release or based on the absence of keep alive messages over PC5) to inform the SMF that the Remote UE(s) have left.

In the case of Registration Update procedure involving SMF change the Remote User IDs and related IP info corresponding to the connected Remote UEs are transferred to the new SMF as part of SM context transfer for the ProSe 5G UE-to-Network Relay.

After being connected to the ProSe 5G UE-to-Network Relay, the Remote UE keeps performing the measurement of the signal strength of the discovery message sent by the ProSe 5G UE-to-Network Relay for relay reselection. The solution can also work when the ProSe 5G UE-to-Network Relay UE connects in Evolved Packet System (EPS) using LTE. In this case for the Remote UE report the procedures defined in the 3GPP TS 23.303 can be used.

In the TR 23.752 v0.3.0, clause 6.7, a Layer 2 (L2) UE-to-Network Relay is described. In this clause, the protocol architecture supporting a L2 UE-to-Network Relay UE is provided. The L2 UE-to-Network Relay UE provides forwarding functionality that can relay any type of traffic over the PC5 link.

The L2 UE-to-Network Relay UE provides the functionality to support connectivity to the 5^{th} Generation System (5GS) for Remote UEs. A UE is considered to be a Remote UE if it has successfully established a PC5 link to the L2 UE-to-Network Relay UE. A Remote UE can be located within NG-RAN coverage or outside of NG-RAN coverage.

FIG. 4 shows a protocol stack for the user plane transport, related to a PDU Session, including an L2 UE-to-Network Relay UE. The PDU layer corresponds to the PDU carried between the Remote UE and the Data Network (DN) over the PDU session. The PDU layer corresponds to the PDU carried between the Remote UE and the Data Network (DN) over the PDU session. It is important to note that the two endpoints of the Packet Data Convergence Protocol (PDCP) link are the Remote UE and the gNB. The relay function is performed below PDCP. This means that data security is ensured between the Remote UE and the gNB without exposing raw data at the UE-to-Network Relay UE.

The adaptation rely layer within the UE-to-Network Relay UE can differentiate between signaling radio bearers (SRBs) and data radio bearers (DRBs) for a particular Remote UE. The adaption relay layer is also responsible for mapping PC5 traffic to one or more DRBs of the Uu. The definition of the adaptation relay layer is under the responsibility of RAN WG2.

FIG. 5 shows a protocol stack of the Non-Access Stratum (NAS) connection for the Remote UE to the NAS-Mobility Management (MM) and NAS-Session Management (SM) components. The NAS messages are transparently transferred between the Remote UE and 5G-Access Network (AN) over the Layer 2 UE-to-Network Relay UE using:
PDCP end-to-end connection where the role of the UE-to-Network Relay UE is to relay the PDUs over the signaling radio bear without any modifications.
N2 connection between the 5G-AN and Access and Mobility Management Function (AMF) over N2.
N3 connection AMF and SMF over N11.

The role of the UE-to-Network Relay UE is to relay the PDUs from the signaling radio bearer without any modifications.

FIG. 6 shows a connection establishment procedure for indirect communication via UE-to-Network Relay UE in TR 23.752. The procedure includes the following steps:
0. If in coverage, the Remote UE and UE-to-Network Relay UE may independently perform the initial registration to the network according to registration procedures in the 3GPP TS 23.502, v16.6.0. The allocated 5G GUTI of the Remote UE is maintained when later NAS signaling between Remote UE and Network is exchanged via the UE-to-Network Relay UE.
1. If in coverage, the Remote UE and UE-to-Network Relay UE independently get the service authorization for indirect communication from the network.
2-3. The Remote UE and UE-to-Network Relay UE perform UE-to-Network Relay UE discovery and selection.
4. Remote UE initiates a one-to-one communication connection with the selected UE-to-Network Relay UE over PC5, by sending an indirect communication request message to the UE-to-Network Relay.
5. If the UE-to-Network Relay UE is in CM_IDLE state, triggered by the communication request received from the Remote UE, the UE-to-Network Relay UE sends a Service Request message over PC5 to its serving AMF.
The Relay's AMF may perform authentication of the UE-to-Network Relay UE based on NAS message validation and if needed the AMF will check the subscription data.
If the UE-to-Network Relay UE is already in CM_CONNECTED state and is authorised to perform Relay service then step 5 is omitted.
6. The UE-to-Network Relay UE sends the indirect communication response message to the Remote UE.
7. Remote UE sends a NAS message to the serving AMF. The NAS message is encapsulated in an RRC message that is sent over PC5 to the UE-to-Network Relay UE, and the UE-to-Network Relay UE forwards the message to the NG-RAN. The NG-RAN derives Remote UE's serving AMF and forwards the NAS message to this AMF.
If Remote UE has not performed the initial registration to the network in step 0, the NAS message is initial registration message. Otherwise, the NAS message is service request message.
If the Remote UE performs initial registration via the UE-to-Network relay, the Remote UE's serving AMF may perform authentication of the Remote UE based on NAS message validation and if needed the Remote UE's AMF checks the subscription data.
For service request case, User Plane connection for PDU Sessions can also be activated. The other steps follow the clause 4.2.3.2 in TS 23.502.
8. Remote UE may trigger the PDU Session Establishment procedure as defined in clause 4.3.2.2 of TS 23.502.
9. The data is transmitted between Remote UE and UPF via UE-to-Network Relay UE and NG-RAN. The UE-to-Network Relay UE forwards all the data messages between the Remote UE and NG-RAN using RAN specified L2 relay method.

As described in clause 6.1 of TR 23.752, the discovery procedure which is being studied for NR Release 17 is based on the 5G Core (5GC) architecture, including authorization and provision, announcing and monitoring procedures, and protocol for discovery as detailed in clause 6.1.2 of TR 23.752.

In EPS, there are two types of ProSe Direct Discovery: open and restricted. Open discovery is the case where there is no explicit permission that is needed from the UE being discovered, whereas restricted discovery only takes place with explicit permission from the UE that is being discovered. Besides, there are two models for ProSe Direct Discovery exists in EPS: Model A and Model B. These two models are re-proposed in this solution as the same mechanism in EPS. And the definition for Model A and Model B is as defined in clause 5.3.1.2 of TS 23.303.

For the direct discovery authorization and provision to the UE, it is expected the AF can provide the groups and/or service information to the Policy Control Function (PCF) via Network Exposure Function (NEF) and the PCF provides the authorization to the UE according to the received information from the Application Function (AF). The authorization and provision procedures in clauses 6.2.2 and 6.2.5 of TS 23.287 are reused to provide at least the following configurations:
1) The AF request sent to the PCF (or via NEF) contains the information as below:
   The service information to be directly discovered over PC5 interface. The service information can contain, e.g. Application identifier;
   The group information (e.g. the external group identifier) to be directly discovered over PC5 interface;
   The information can per announcing and monitoring direction for Model A or per discoverer UE and discoveree UE for Model B;
   The area information, e.g. geographical information (longitude/latitude, zip code, etc).
2) The provision to the UE from PCF, contains the following information based on the information received from the AF and local policy:
   The service information to be directly discovered over PC5 interface. The service information can contain, e.g. Application identifier;
   The group information (e.g. the external group identifier) to be directly discovered over PC5 interface;
   The area information used for direct discovery over PC5 interface. The area information could be geographical Tracking Area (TA) list. It is expected PCF will map the area information provided by AF to a list of TAs.
   Security parameters used for direct discovery over PC5.

If the AMF determines the UE is authorized to use direct discovery based on the authorized area information, the AMF provides the UE being authorized to use direct discovery over PC5 interface to corresponding NG-RAN during N2 establishment for the UE.

FIG. 7 shows a discovery procedure in TR 23.752. The procedure includes the following steps:
0. The user may obtain ProSe application user ID and ProSe application code for ProSe direct discovery using application layer mechanisms. The application layer in the UE provides application user ID and the application identifier to the ProSe Application Function. The ProSe Application Function allocates a ProSe application user ID and ProSe application code to the application layer in the UE.
1. The UE obtains the authorization and provision for announcing discovery and/or for monitoring/solicitation discovery as defined in clauses 6.2.2 and 6.2.5 of TS 23.287.
2a. When the announcing UE is triggered e.g. by an upper layer application to announce availability for interested groups and/or for interested applications, if the UE is authorized to perform the announcing UE procedure for the interested groups and/or the interested applications in step 1, then the UE shall generate a PC5 direct discovery message for announcement and includes the following information in this message. The announcing UE computes a security protection element (e.g. for integrity protection) and appends it to the PC5 message:
1) ProSe UE ID e.g. ProSe application user ID, Layer 2 ID.
2) The group ID(s) provided by the application layer.
3) The application ID(s) or ProSe application code(s) provided the application layer.
When the monitoring UE is triggered e.g. by an upper layer application or by the user to monitor proximity of other UEs for the interested group(s) and/or interested applications, and if the UE is authorized to perform the monitoring procedure for the group(s) and/or applications, then the UE monitors the discovery message. The monitoring UE verifies the security protection element using the provisioned security parameters corresponding to the application. If the verification of the security protection element succeeds, the service is successfully discovered by the monitoring UE. The monitoring UE may then notify the application layer using the result of the discovery.
2b. When the discoverer UE is triggered e.g. by an upper layer application or by the user to discover other UEs for the interested group(s) and/or interested applications, and if the UE is authorized to perform the discovery solicitation procedure for the group(s) and/or applications in step 1, then the UE sends solicitation message with the information of discoverer ProSe UE ID, application ID(s) or ProSe application code(s), group ID(s). The discoverer UE computes a security protection element (e.g. for integrity protection) and appends it to the PC5 message.
If the discoveree UE is able to and authorised to respond to the discovery solicitation according to the received information in the solicitation message, then it responds to the discovery message with the discoveree ProSe UE ID, the supported application ID(s) or ProSe application code(s) and group ID(s).
3a. If the monitoring UE/discoverer UE wants to request metadata corresponding to the discovered service in step 2, the monitoring UE/discoverer UE may send a unicast metadata request message to request discovery metadata. The monitoring UE/discoverer UE may use the Layer 2 ID of announcing UE/discoveree UE (received in step 2a or 2b) to send the Metadata Request message.
3b. The announcing UE/discoveree UE responds with the Metadata Response message. The announcing UE/discoveree UE includes the metadata information in the Metadata Response message.

### SUMMARY

In the meeting RAN2 #112-e, the following proposals have been agreed:
Proposal 1: Radio measurements at PC5 interface are considered as part of relay (re)selection criteria (e.g., in Step 2, Discovery Procedure, of FIG. 3 or in Step 2 & 3, UE-to-Network Relay discovery and selection, in FIG. 6).
Proposal 2: Remote UE at least uses “Radio signal strength measurements of Sidelink Discovery Messages” to evaluate whether PC5 link quality of a relay UE satisfies relay selection and reselection criterion.
Proposal 3: Remote UE may also use Sidelink Reference Signal Received Power (SL-RSRP) measurements on the Sidelink unicast link to evaluate whether PC5 link quality with a relay UE satisfies relay reselection criterion. Details e.g., in case of no transmission on the unicast link will be discussed in Work Item (WI) phase.

It is an object of the present disclosure to provide a terminal device, a network node, and methods therein for measurement reporting.

According to a first aspect of the present disclosure, a method in a first terminal device is provided. The method includes: obtaining a first measurement result for a first link between the first terminal device and a second terminal device and/or a second measurement result for a second link between the first terminal device and a network node; and transmitting the first measurement result and/or the second measurement result.

In an embodiment, the first measurement result and/or the second measurement result may be obtained by measuring the first link and/or the second link by the first terminal device, or receiving from the second terminal device the first measurement result and/or the second measurement result as obtained by measuring the first link and/or the second link by the second terminal device.

In an embodiment, the first measurement result and/or the second measurement result may be received via RRC signaling, MAC CE, or a control PDU.

In an embodiment, the first link and the second link may be measured in accordance with a unified measurement configuration or with separate measurement configurations.

In an embodiment, the unified measurement configuration, or each of the separate measurement configurations, may include one or more of: one or more measurement quantities, one or more measurement objects, one or more time and/or frequency resources to be measured, one or more measurement identities, one or more measurement gaps, or one or more measurement reporting configurations.

In an embodiment, the one or more measurement quantities may include one or more of: Reference Signal Received Power (RSRP), Reference Signal Received Quality (RSRQ), Received Signal Strength Indicator (RSSI), Signal to Interference plus Noise Ratio (SINR), Signal to Interference Ratio (SIR), or channel occupancy or channel busy ratio.

In an embodiment, at least one of the one or more measurement objects may be associated with one or more resource pools.

In an embodiment, the one or more resource pools may include an exceptional resource pool that is used only for measurement during a discovery procedure.

In an embodiment, the one or more time and/or frequency resources to be measured may be dependent on an RRC state of the first or second terminal device.

In an embodiment, the one or more measurement identities may include one or more of: a measurement identity assigned from a measurement identity pool used for non-discovery-related measurement, or a measurement identity assigned from a measurement identity pool used only for discovery-related measurement.

In an embodiment, the first link and the second link may be measured in parallel or in a time-division manner.

In an embodiment, the unified measurement configuration, or each of the separate measurement configurations, may be preconfigured, or may be received from a network node, the second terminal device, or another terminal device controlling the first terminal device and the second terminal device, via system information, RRC signaling, MAC CE, paging message, or Layer 1 (L1) signaling.

In an embodiment, the first link and/or the second link may be a non-serving link and the operation of measuring of the first link and/or the second link may be in response to: a radio quality of a current serving link being lower than a threshold, or a trigger from a network node, the second terminal device, or another terminal device controlling the first terminal device and the second terminal device, for the first or second terminal device to perform the measuring.

In an embodiment, the threshold may be higher than a radio quality threshold for triggering a relay reselection.

In an embodiment, the threshold may be dependent on an RRC state of the first or second terminal device.

In an embodiment, the first measurement result and/or the second measurement result may be transmitted to the second terminal device.

In an embodiment, the first measurement result and/or the second measurement result may be transmitted via RRC signaling, MAC CE, or a control PDU.

In an embodiment, the first terminal device may be a remote UE, and the second terminal device may be a relay UE in an L2 or L3 UE-to-Network Relay configuration.

In an embodiment, when the network node is a serving network node of the first terminal device, the second measurement result may be received from the second terminal device as a measurement result for a Uu link between the second terminal device and the network node.

In an embodiment, when the network node is a non-serving network node of the first terminal device, the second link may be measured by the first terminal device.

In an embodiment, the first measurement result may be transmitted in a first measurement report to the network node via the second terminal device, and/or the second measurement result may be transmitted in the first measurement report or a second measurement report to the network node via the second terminal device.

In an embodiment, the first measurement report and/or the second measurement report may be transmitted in a PC5-RRC message or a Uu RRC message.

In an embodiment, the first measurement report and the second measurement report may be included in separate information elements or containers.

In an embodiment, the first terminal device may be a relay UE, and the second terminal device is a remote UE in an L2 or L3 UE-to-Network Relay configuration.

In an embodiment, the first measurement result may be transmitted in a first measurement report to the network node, and/or the second measurement result may be transmitted in the first measurement report or a second measurement report to the network node.

In an embodiment, the first measurement report and/or the second measurement report may be transmitted in a Uu RRC message.

In an embodiment, the first measurement report and/or the second measurement report may be received from the second terminal device in a PC5-RRC message or a Uu RRC message.

In an embodiment, the first measurement report and/or the second measurement report may be transmitted periodically or when one or more of the following conditions are satisfied:
a measured quality of a serving Uu link is lower than a threshold, while a measured quality of a non-serving PC5 link is higher than another threshold,
a measured quality of a serving Uu link is lower than a threshold, while a measured quality of a non-serving Uu link is higher than another threshold,
a measured quality of any one of the first link and the second link is lower than a threshold,
a measured quality of one of the first link and the second link is lower than a threshold, while a measured quality of the other one of the first link and the second link is higher than another threshold,
a measured quality of the first link is lower than a threshold, while a measured quality of an inter-Radio Access Technology, RAT, or frequency link on which the first terminal device and the second terminal device are operating or capable of operating is higher than another threshold,
an overall measured quality of the first link and the second link is lower than a threshold,
a measured quality of one of the first link and the second link is lower or higher than a measured quality of the other one of the first link and the second link by an offset, or
a measured quality of one of the first link and the second link is lower than a threshold by an offset dependent on a measured quality of the other one of the first link and the second link.

In an embodiment, the first measurement report and/or the second measurement report may be transmitted when one or more of the following conditions are satisfied:
a measured quality of an end-to-end serving link is higher or lower than a threshold,
a measured interference of an end-to-end serving link is higher than a threshold
a measured quality of a non-serving link is higher than an end-to-end serving link or a threshold, or
a measured quality of an end-to-end serving link is lower than a threshold, while a measured quality of a non-serving link is higher than another threshold.

In an embodiment, the end-to-end serving link may include the first link, as a PC5 link, and the second link, as a Uu link, between the relay UE and the network node, and the measured quality of the end-to-end serving link may be represented as a function of the first measurement result and/or second measurement result, and/or the non-serving link may be a PC5 link, a Uu link, or an end-to-end link including a PC5 link and a Uu link.

In an embodiment, the first measurement report and/or the second measurement report may include one or more of: one or more measurement identities, a measurement result for each of one or more serving frequencies, a measurement result for each of one or more inter-RAT or frequency links, an indication of the first link and/or the second link with which the first measurement result and/or the second measurement result is associated, a RAT or frequency with which the first measurement result and/or the second measurement result is associated, or an identifier of the first terminal device or the second terminal device.

In an embodiment, the first link may be a serving or non-serving PC5 link, and the second link may be a serving or non-serving Uu link.

According to a second aspect of the present disclosure, a first terminal device is provided. The first terminal device includes a transceiver, a processor and a memory. The memory contains instructions executable by the processor whereby the first terminal device is operative to perform the method according to the above first aspect.

According to a third aspect of the present disclosure, a computer readable storage medium is provided. The computer readable storage medium has computer program instructions stored thereon. The computer program instructions, when executed by a processor in a first terminal device, cause the first terminal device to perform the method according to the above first aspect.

According to a fourth aspect of the present disclosure, a method in a network node is provided. The method includes: receiving, from a first terminal device or a second terminal device, a first measurement result for a first link between the first terminal device and the second terminal device and a second measurement result for a second link between the first terminal device and the network node.

In an embodiment, the first measurement result and the second measurement result may be received in a single measurement report or in separate measurement reports.

In an embodiment, the method may further include: transmitting, to the first terminal device and/or the second terminal device, a unified measurement configuration or separate measurement configurations for measuring the first link and/or the second link.

In an embodiment, the unified measurement configuration, or each of the separate measurement configurations, may include one or more of: one or more measurement quantities, one or more measurement objects, one or more time and/or frequency resources to be measured, one or more measurement identities, one or more measurement gaps, or one or more measurement reporting configurations.

In an embodiment, the one or more measurement quantities may include one or more of: RSRP, RSRQ, RSSI, SINR, SIR, or channel occupancy or channel busy ratio.

In an embodiment, at least one of the one or more measurement objects may be associated with one or more resource pools.

In an embodiment, the one or more resource pools may include an exceptional resource pool that is used only for measurement during a discovery procedure.

In an embodiment, the one or more time and/or frequency resources to be measured may be dependent on an RRC state of the first or second terminal device.

In an embodiment, the one or more measurement identities may include one or more of: a measurement identity assigned from a measurement identity pool used for non-discovery-related measurement, or a measurement identity assigned from a measurement identity pool used only for discovery-related measurement.

In an embodiment, the unified measurement configuration, or each of the separate measurement configurations, may be transmitted via system information, RRC signaling, MAC CE, paging message, or L1 signaling.

In an embodiment, the method may further include: transmitting, to the first terminal device and/or the second terminal device, an indication indicating which of the first terminal device and the second terminal device is to measure the first link or the second link, and/or which of the first terminal device and the second terminal device is to transmit the first measurement result and/or the second measurement result.

In an embodiment, the first terminal device may be a remote UE, and the second terminal device may be a relay UE in an L2 or L3 UE-to-Network Relay configuration, or the first terminal device may be a relay UE, and the second terminal device may be a remote UE in an L2 or L3 UE-to-Network Relay configuration.

According to a fifth aspect of the present disclosure, a network node is provided. The network node includes a transceiver, a processor and a memory. The memory contains instructions executable by the processor whereby the network node is operative to perform the method according to the above fourth aspect.

According to a sixth aspect of the present disclosure, a computer readable storage medium is provided. The computer readable storage medium has computer program instructions stored thereon. The computer program instructions, when executed by a processor in a network node, cause the network node to perform the method according to the above fourth aspect.

With the embodiments of the present disclosure, a terminal device can obtain a sidelink (PC5 link) measurement result and/or a Uu link measurement result, and transmit the measurement result(s) to a network node (e.g., in a measurement report) or another terminal device, such that the sidelink measurement result and/or the Uu link measurement result can be reported properly.

### BRIEF DESCRIPTION OF THE DRAWINGS

The above and other objects, features and advantages will be more apparent from the following description of embodiments with reference to the figures, in which:

FIG. 1 is a schematic diagram showing an architecture model using a ProSe 5G UE-to-Network Relay;

FIG. 2 is a schematic diagram showing a protocol stack for L3 UE-to-Network Relay;

FIG. 3 is a schematic diagram showing a signaling sequence for ProSe UE-to-Network Relay;

FIG. 4 is a schematic diagram showing a protocol stack for the user plane transport, including an L2 UE-to-Network Relay UE;

FIG. 5 is a schematic diagram showing a protocol stack of the NAS connection for the Remote UE to the NAS-MM and NAS-SM components;

FIG. 6 is a schematic diagram showing a connection establishment procedure for indirect communication via UE-to-Network Relay UE,

FIG. 7 is a schematic diagram showing a discovery procedure;

FIG. 8 is a flowchart illustrating a method in a first terminal device according to an embodiment of the present disclosure;

FIG. 9 is a schematic diagram showing a measurement reporting procedure according to an embodiment of the present disclosure;

FIG. 10 is a flowchart illustrating a method in a network node according to an embodiment of the present disclosure;

FIG. 11 is a block diagram of a first terminal device according to an embodiment of the present disclosure;

FIG. 12 is a block diagram of a first terminal device according to another embodiment of the present disclosure;

FIG. 13 is a block diagram of a network node according to an embodiment of the present disclosure;

FIG. 14 is a block diagram of a network node according to another embodiment of the present disclosure;

FIG. 15 schematically illustrates a telecommunication network connected via an intermediate network to a host computer;

FIG. 16 is a generalized block diagram of a host computer communicating via a base station with a user equipment over a partially wireless connection; and

FIGS. 17 to 20 are flowcharts illustrating methods implemented in a communication system including a host computer, a base station and a user equipment.

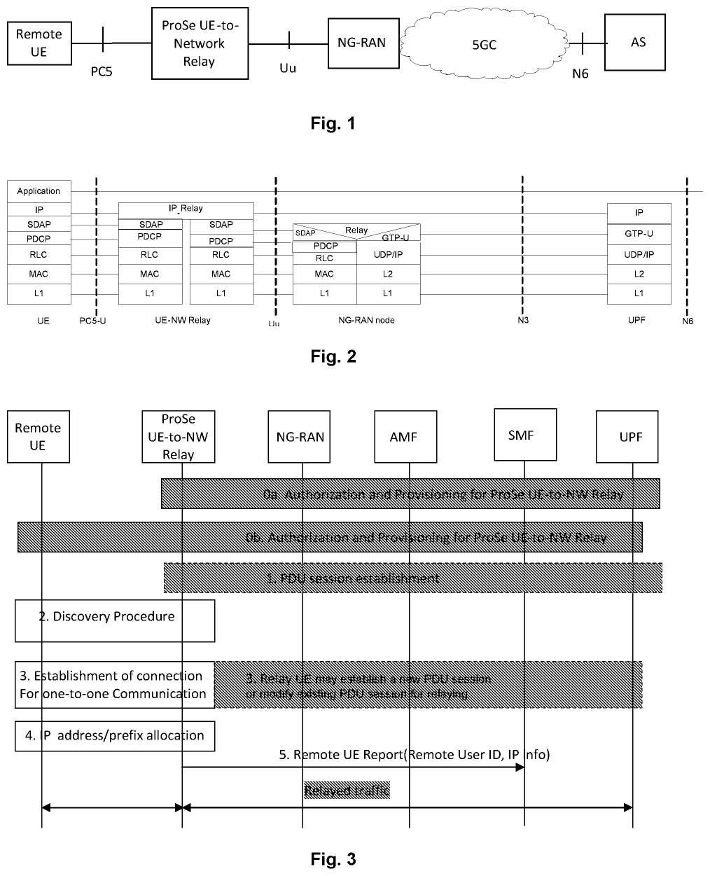

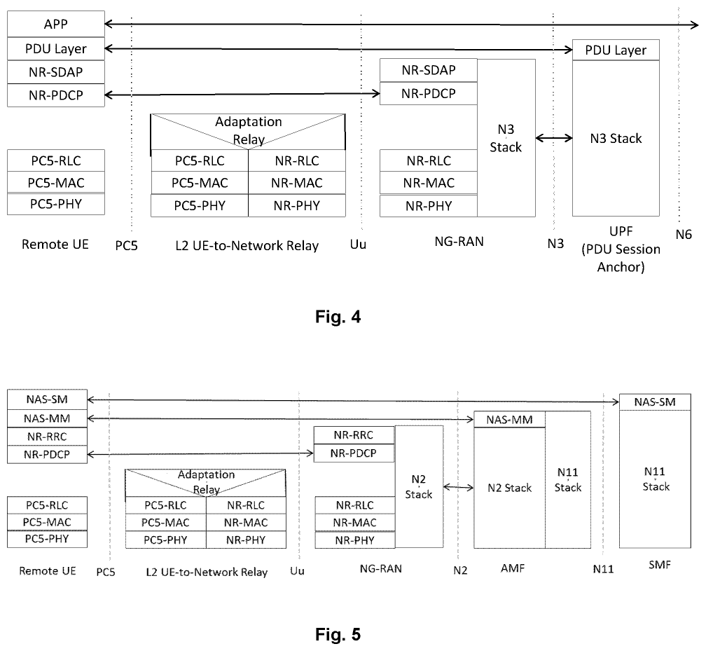

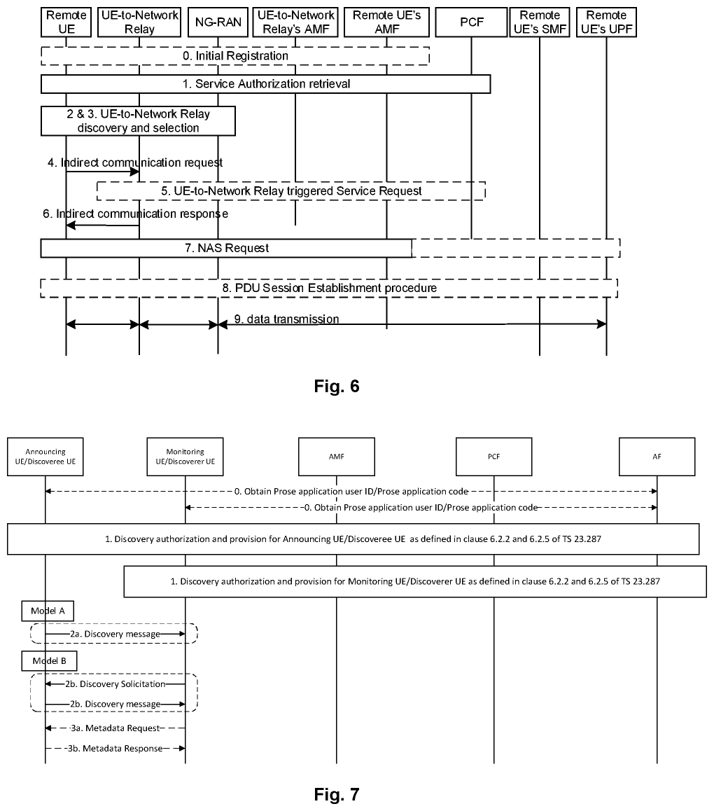

### DETAILED DESCRIPTION

As used herein, the term “wireless communication network” refers to a network following any suitable communication standards, such as NR, LTE-Advanced (LTE-A), LTE, Wideband Code Division Multiple Access (WCDMA), High-Speed Packet Access (HSPA), and so on. Furthermore, the communications between a terminal device and a network node in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable 1G (the first generation), 2G (the second generation), 2.5G, 2.75G, 3G (the third generation), 4G (the fourth generation), 4.5G, 5G (the fifth generation) communication protocols, wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

The term “network node” or “network device” refers to a device in a wireless communication network via which a terminal device accesses the network and receives services therefrom. The network node or network device refers to a base station (BS), an access point (AP), or any other suitable device in the wireless communication network. The BS may be, for example, a node B (NodeB or NB), an evolved NodeB (eNodeB or eNB), or a (next) generation (gNB), a Remote Radio Unit (RRU), a radio header (RH), a remote radio head (RRH), a relay, a low power node such as a femto, a pico, and so forth. Yet further examples of the network node may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network node may represent any suitable device (or group of devices) capable, configured, arranged, and/or operable to enable and/or provide a terminal device access to the wireless communication network or to provide some service to a terminal device that has accessed the wireless communication network.

The term “terminal device” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, desktop computers, image capture terminal devices such as digital cameras, gaming terminal devices, music storage and playback appliances, a mobile phone, a cellular phone, a smart phone, voice over IP (VoIP) phones, wireless local loop phones, tablets, personal digital assistants (PDAs), wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

The terminal device may support device-to-device (D2D) communication, for example by implementing a 3GPP standard for sidelink communication, and may in this case be referred to as a D2D communication device.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink transmission refers to a transmission from the network node to a terminal device, and an uplink transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

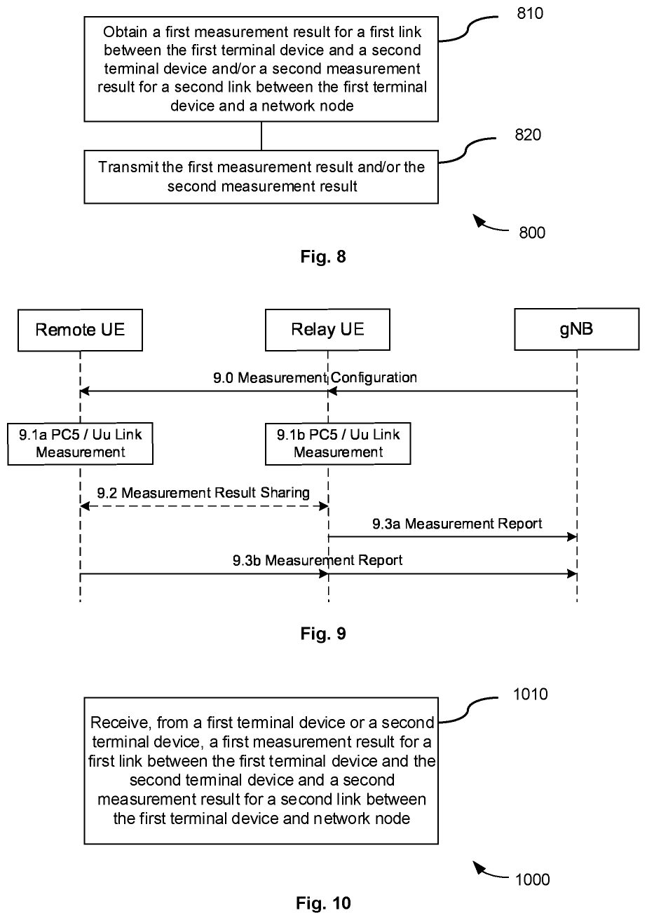

FIG. 8 is a flowchart illustrating a method 800 according to an embodiment of the present disclosure. The method 800 can be performed at a first terminal device, e.g., a remote UE or a relay UE in an L2 or L3 UE-to-Network Relay configuration as described above.

At block 810, a first measurement result for a first link between the first terminal device and a second terminal device and/or a second measurement result for a second link between the first terminal device and a network node is obtained.

Here, when the first terminal device is a remote UE, the second terminal device can be a relay UE, or when the first terminal device is a relay UE, the second terminal device can be a remote UE. The first link can be a serving or non-serving PC5 link. A serving PC5 link means that the PC5 unicast link has been established between the first terminal device and the second terminal device, while a non-serving PC5 link (or interface) means that no PC5 unicast link has been established between the first terminal device and the second terminal device and may refer to a PC5 interface towards the second terminal device or a PC5 interface for groupcast or broadcast communication with the second terminal device. The second link can be a serving or non-serving Uu link. A terminal device may have one or more serving Uu links with one or more serving cells belonging to same or different network nodes (e.g., gNBs), and one or more non-serving Uu links with one or more neighboring cells belonging to same or different network nodes (e.g., gNBs).

The PC5 link(s) or interface(s) and the Uu link(s) or cell(s) to be measured may be deployed in same or different RATs and/or at same or different frequency bands.

In the block 810, the first measurement result and/or the second measurement result can be obtained by measuring the first link and/or the second link by the first terminal device. Alternatively, in the block 810, the first measurement result and/or the second measurement result can be obtained by receiving from the second terminal device the first measurement result and/or the second measurement result as obtained by measuring the first link and/or the second link by the second terminal device. For example, the first measurement result and/or the second measurement result is received via RRC (e.g., PC5-RRC) signaling, MAC CE, or a control PDU, e.g., of a protocol layer such as Service Data Adaptation Protocol (SDAP), PDCP, or Radio Link Control (RLC).

In an example, the first link and the second link can be measured in accordance with a unified measurement configuration. For example, the remote UE and/or the relay UE can be configured with a unified measurement configuration containing measurement parameters for both Uu links and PC5 link or interfaces. The measurement configuration may be associated with an RRC connection (Uu RRC connection or PC5 RRC connection). Alternatively, the first link and the second link can be measured in accordance with separate measurement configurations. For example, the remote UE (or the relay UE) can be configured with one measurement configuration associated with a PC5 RRC connection between the UEs, and one measurement configuration associated with a Uu RRC connection between the remote UE (or the relay UE) and the network node. When the remote UE or the relay UE has more than one serving PC5 RRC connections (e.g., with one or more terminal devices), it can be configured with one measurement configuration for each PC5 RRC connection.

The measurement configuration includes one or more of: one or more measurement quantities, one or more measurement objects, one or more time and/or frequency resources to be measured, one or more measurement identities, one or more measurement gaps, or one or more measurement reporting configurations.

Some of the parameters included in the measurement configuration will be explained as follows, referring to TS 38.331 V 16.2.0:

1. Measurement objects: A list of objects on which the UE shall perform the measurements.
For intra-frequency and inter-frequency measurements a measurement object indicates the frequency/time location and subcarrier spacing of reference signals to be measured. Associated with this measurement object, the network may configure a list of cell specific offsets, a list of ‘blacklisted’ cells and a list of ‘whitelisted’ cells. Blacklisted cells are not applicable in event evaluation or measurement reporting. Whitelisted cells are the only ones applicable in event evaluation or measurement reporting.
The measObjectId of the measurement object which corresponds to each serving cell is indicated by servingCellIMO within the serving cell configuration.
For inter-RAT Evolved Universal Terrestrial Radio Access (E-UTRA) measurements a measurement object is a single E-UTRA carrier frequency. Associated with this E-UTRA carrier frequency, the network can configure a list of cell specific offsets, a list of ‘blacklisted’ cells and a list of ‘whitelisted’ cells. Blacklisted cells are not applicable in event evaluation or measurement reporting. Whitelisted cells are the only ones applicable in event evaluation or measurement reporting.
For inter-RAT UTRA—Frequency Division Duplex (FDD) measurements a measurement object is a set of cells on a single UTRA-FDD carrier frequency.
For Constant Bit Rate (CBR) measurement of NR sidelink communication, a measurement object is a set of transmission resource pool(s) on a single carrier frequency for NR sidelink communication.
For Cross Link Interface (CLI) measurements a measurement object indicates the frequency/time location of Sounding Reference Signal (SRS) resources and/or CLI-RSSI resources, and subcarrier spacing of SRS resources to be measured.

2. Reporting configurations: A list of reporting configurations where there can be one or multiple reporting configurations per measurement object. Each measurement reporting configuration consists of the following:
Reporting criterion: The criterion that triggers the UE to send a measurement report. This can either be periodical or a single event description.
Reference Signal (RS) type: The RS that the UE uses for beam and cell measurement results (Synchronization Signal (SS)/Physical Broadcast Channel (PBCH) block or Channel State Information (CSI)-Reference Signal (RS)).
Reporting format: The quantities per cell and per beam that the UE includes in the measurement report (e.g. RSRP) and other associated information such as the maximum number of cells and the maximum number beams per cell to report.

In case of conditional reconfiguration, each configuration consists of the following:
Execution criteria: The criteria the UE uses for conditional reconfiguration execution.
RS type: The RS that the UE uses for obtaining beam and cell measurement results (SS/PBCH block-based or CSI-RS-based), used for evaluating conditional reconfiguration execution condition.

3. Measurement identities: For measurement reporting, a list of measurement identities where each measurement identity links one measurement object with one reporting configuration. By configuring multiple measurement identities, it is possible to link more than one measurement object to the same reporting configuration, as well as to link more than one reporting configuration to the same measurement object. The measurement identity is also included in the measurement report that triggered the reporting, serving as a reference to the network. For conditional reconfiguration triggering, one measurement identity links to exactly one conditional reconfiguration trigger configuration. And up to 2 measurement identities can be linked to one conditional reconfiguration execution condition.

4. Quantity configurations: The quantity configuration defines the measurement filtering configuration used for all event evaluation and related reporting, and for periodical reporting of that measurement. For NR measurements, the network may configure up to 2 quantity configurations with a reference in the NR measurement object to the configuration that is to be used. In each configuration, different filter coefficients can be configured for different measurement quantities, for different RS types, and for measurements per cell and per beam.

5. Measurement gaps: Periods that the UE may use to perform measurements.

In an example, the one or more measurement quantities may include one or more of: RSRP, RSRQ, RSSI, SINR, SIR, or channel occupancy or channel busy ratio.

In an example, at least one of the one or more measurement objects may be associated with one or more resource pools. For example, the one or more resource pools may include an exceptional resource pool that is used only for measurement during a discovery procedure. The resource pools may belong to a same frequency band or to different frequency bands.

In an example, the one or more time and/or frequency resources to be measured may be dependent on an RRC state of the first or second terminal device. For example, different number of PC5 frequencies can be measured when the first terminal device is in different RRC states.

In an example, the one or more measurement identities may include one or more of: a measurement identity assigned from a measurement identity pool used for non-discovery-related measurement (measurement not for discovery purposes), or a measurement identity assigned from a measurement identity pool used only for discovery-related measurement (measurement for discovery purposes only).

In an example, the first link and the second link may be measured in parallel. For example, a remote UE may support multiple connections (e.g., a direct connection to a relay UE, a direct connection to a non-serving gNB, an indirect connection to a serving gNB via the relay UE, or a direct connection to another neighbor UE), and a relay UE may support multiple connections (e.g., a direct connection to a remote UE, a direct connection to a non-serving gNB, a direct connection to a serving gNB, or a direct connection to another neighbor UE). In order to support parallel measurements, the remote UE or the relay UE may be configured with separate Radio Frequency (RF) chains for different connections. Alternatively, the first link and the second link may be measured in a time-division manner, e.g., in different time slots. In this case, the remote UE or the relay UE may be configured with a shared RF chain between multiple connections. The UE can switch between Uu and PC5 links at different slots. At any given time slot, the UE only measures one connection. Measurement gaps or switching pattern in time domain between the connections may be configured accordingly.

In an example, the unified measurement configuration, or each of the separate measurement configurations, may be preconfigured. Alternatively, the remote UE or the relay UE may receive the unified measurement configuration, or at least one of the separate measurement configurations, from a network node (e.g., a serving gNB of the remote UE or the relay UE) or another UE controlling the relay UE or remote UE via system information, RRC signaling, MAC CE, paging message, or L1 signaling (such as DCI or SCI). The remote UE may receive the unified measurement configuration, or at least one of the separate measurement configurations, from the relay UE via system information, RRC signaling, MAC CE, paging message, or L1 signaling. For example, the measurement configuration(s) for the remote UE can be included in an RRC message transmitted from a network node or a controlling UE to the relay UE, as information element(s) or within a container. The relay UE can then forward the measurement configuration(s) to the remote UE via PC5-RRC signaling. When the container is used, the relay UE can simply include the container in a PC5-RRC message without decoding it.

In an example, the first link and/or the second link may be a non-serving link. The measuring of the first link and/or the second link may be in response to a radio quality of a current serving link (PC5 or Uu link) being lower than a threshold. The threshold may be higher than a radio quality threshold for triggering a relay reselection. That is, the radio quality of the current serving sidelink being lower than the threshold may trigger early measurement such that the remote UE or the relay UE can perform measurement on non-serving links before the serving link becomes too bad. This threshold may be dependent on an RRC state of the remote UE or the relay UE, e.g., a higher threshold for RRC_CONNECTED than for RRC_INACTIVE or RRC_IDLE. Alternatively, the measuring of the first link and/or the second link may be in response to a trigger from a network node, the remote UE or the relay UE, or another UE controlling the remote UE and the relay UE, for the remote UE or the relay UE to perform the measuring. This allows the remote UE (or the relay UE) to request the relay UE (or the remote UE) to perform the measuring and provide the remote UE (or the relay UE) with a measurement result accordingly, so as to reduce power consumption of the remote UE (or the relay UE).

At block 820, the first measurement result and/or the second measurement result is transmitted.

In an example, the remote UE (or the relay UE) may transmit the first measurement result and/or the second measurement result to the relay UE (or the remote UE). For example, the first measurement result and/or the second measurement result is transmitted via RRC signaling, MAC CE, or a control PDU (e.g., of a protocol layer such as SDAP, PDCP, or RLC).

Here, in the block 810, when the network node is a serving network node of the remote UE and the remote UE does not have a direct Uu connection with the network node, the remote UE can use the relay UE's measurement result for the Uu link between the relay UE and the network node. In this case, the remote UE can receive the second measurement result from the relay UE as a measurement result for a Uu link between the relay UE and the network node.

On the other hand, in the block 810, when the network node is a non-serving network node of the remote UE, the second link can be measured by the remote UE itself.

In an example, in the block 820, the remote UE can transmit the first measurement result in a measurement report to the network node via the relay UE. The remote UE can also transmit the second measurement result, in the same measurement report or a different measurement report, to the network node via the relay UE. The first measurement report and/or the second measurement report can be transmitted in a PC5-RRC message or a Uu RRC message. The first measurement report and the second measurement report can be included in separate information elements or containers (e.g., OCTET STRING).

In another example, in the block 820, the relay UE can transmit the first measurement result in a measurement report to the network node. The relay UE can also transmit the second measurement result, in the same measurement report or a different measurement report, to the network node. The first measurement report and/or the second measurement report may be transmitted in a Uu RRC message. For example, the first measurement report and/or the second measurement report may be received from the relay UE in a PC5-RRC message or a Uu RRC message, and then forwarded to the network node.

For example, the remote UE or the relay UE can generate and transmit one or more measurement reports to the network node according to any of the following options:

Option 1: The remote UE or the relay UE generates separate measurement reports containing measurement results for Uu links/cells and PC5 interfaces/links, respectively. This option may be applicable when different measurement configurations are provided for Uu links/cells and PC5 interfaces/links respectively.

Option 2: The remote UE or the relay UE generates a combined measurement report containing measurement results for both Uu links/cells and PC5 interfaces/links (i.e., cross connection/RAT measurement report). This option may be applicable when a unified measurement configuration for both Uu links/cells and PC5 interfaces/links is provided. Alternatively, regardless of whether a unified measurement configuration or separate measurement configurations are provided for Uu links/cells and PC5 interfaces/links, the remote UE or the relay UE can generate a combined measurement report containing measurement results for both Uu links/cells and PC5 interfaces/links. The remote UE or the relay UE may be configured/preconfigured with a parameter indicating whether it is allowed to generate a cross connection/RAT measurement report. The remote UE or the relay UE may also be configured/preconfigured with how to generate a combined measurement report containing measurement results for both Uu links/cells and PC5 interfaces/links.

For either of the above options, in a measurement report, the remote UE or the relay UE can explicitly indicate whether a reported measurement result is a measurement on the Uu link or a measurement on the sidelink. Alternatively, no explicit indicator is added but instead a mapping between a Uu link quality and a sidelink link quality is (pre)configured, and the remote UE or the relay UE can adjust the Uu measurement result or the sidelink measurement result according to the mapping and then put the adjusted measurement results in the measurement report. It may also be (pre)configured whether the Uu measurement result or the sidelink measurement result should be adjusted.

FIG. 9 shows a measurement reporting procedure according to an embodiment of the present disclosure. At 9.0, a gNB transmits a measurement configuration (a unified configuration or separate configurations for PC5 link measurement and Uu link measurement) to a remote UE and a relay UE. Alternatively, the measurement configuration(s) may be preconfigured, e.g., in a specification, or configured by a controlling UE, as described above. At 9.1a, the remote UE measures a PC5 link or Uu link (e.g., a serving Uu link towards a non-serving gNB) in accordance with the measurement configuration. Alternatively or additionally, at 9.1b, the remote UE measures a PC5 link or Uu link (e.g., a serving Uu link with a serving gNB) in accordance with the measurement configuration. Here, the remote UE, the relay UE, or both can measure a PC5 link between the two UEs and/or a non-serving Uu link. In order to reduce power consumption, it can be configured/preconfigured to allow only one of the remote UE and the relay UE to measure a particular link. At 9.2, the remote UE and the relay UE can share their measurement results with each other, e.g., via PC5-RRC signaling, MAC CE, or control PDU. For example, the relay UE can provide the remote UE with a measurement result for the serving Uu link (which the remote UE cannot measure by itself). At 9.3a, the relay UE can transmit a measurement report to the gNB, containing the PC5 link measurement result(s) and the Uu link measurement result(s), either obtained by measuring the link(s) at the relay UE itself or by receiving them from the remote UE. Alternatively, at 9.3b, the remote UE can transmit a measurement report to the gNB via the relay UE, containing the PC5 link measurement result(s) and the Uu link measurement result(s), either obtained by measuring the link(s) at the remote UE itself or by receiving them from the relay UE. Alternatively, the relay UE can transmit a measurement report to the gNB, containing the PC5 link measurement result(s) and the Uu link measurement result(s) obtained by measuring the link(s) at the relay UE itself, while the remote UE can transmit a measurement report to the gNB via the relay UE, containing the PC5 link measurement result(s) and the Uu link measurement result(s) obtained by measuring the link(s) at the remote UE itself.

For example, to avoid redundant reporting of an end-to-end serving link (including a PC5 link between a remote UE and a relay UE and a Uu link between the relay UE and a gNB), when reporting the measurement results to the gNB, the following options can be applied:

Option 1: The remote UE and the relay UE report the measurement results independently. This basically means that the remote UE reports the measurement result for the PC5 link to the relay UE and that the relay UE reports the measurement results for the PC5 link and the Uu link to the gNB. The relay UE may choose not to measure the PC5 link by itself. When reporting the measurement results to the gNB, the relay UE has the following alternatives:
a. The relay UE reports the measurement results for the PC5 link and the Uu link in the same Uu RRC message but in separate information elements or containers (e.g., OCTET STRING). In this case, the gNB will be able to distinguish which measurement result belongs to the PC5 link and which measurement result belongs to the Uu link.
b. The relay UE calculates a value/report/structure as a function (e.g., average (e.g., weighted average) or sum) of the measurement results for the PC5 link and the Uu link, and provides this value/report/structure to the gNB. In such a way, the gNB will not distinguish if the value/report/structure is for the measurement result for the PC5 link or the Uu link, but will have an overall estimate on a channel quality of the PC5 link and the Uu link, i.e., an end-to-end link quality.

Option 2: The remote UE reports the measurement result for the PC5 link to the gNB via the relay UE, and the relay UE reports the measurement result for the Uu link to the gNB. The relay UE may choose not to measure the PC5 link by itself. In this case, the remote UE can include the measurements result for the PC5 link in a Uu RRC message and the relay UE may simply forward the Uu RRC message to the gNB without decoding it. Once the gNB receives both measurement results for the PC5 link and the Uu link, it can combine them to obtain an end-to-end link quality.

Option 3: The relay UE reports the measurement result for the Uu link to the remote UE, and the remote UE reports the measurement results for the PC5 link and the Uu link to the gNB. The relay UE may choose not to measure the PC5 link by itself. In such a case, the relay UE can transmit the measurement result of the Uu link in a PC5 RRC message to the remote UE. Once receiving such measurement result from the relay UE, the remote UE reports a combined measurement result for the PC5 link and the Uu link to the gNB according to the alternatives described in Option 1.

In an example, it can be preconfigured or configured by the network node or a controlling UE which option should be used to report the measurement results. Different options may be configured for different UEs and/or different RRC states.

The present disclosure also applies when a plurality of remote UEs are connected to one relay UE, or when one remote UE is connected to a plurality of relay UEs.

In an example, the first measurement report and/or the second measurement report can be transmitted periodically or when one or more of the following conditions are satisfied:
a measured quality of a serving Uu link is lower than a threshold, while a measured quality of a non-serving PC5 link is higher than another threshold,
a measured quality of a serving Uu link is lower than a threshold, while a measured quality of a non-serving Uu link is higher than another threshold,
a measured quality of any one of the first link and the second link is lower than a threshold,
a measured quality of one of the first link and the second link is lower than a threshold, while a measured quality of the other one of the first link and the second link is higher than another threshold,
a measured quality of the first link is lower than a threshold, while a measured quality of an inter-RAT or frequency link on which the first terminal device and the second terminal device are operating or capable of operating is higher than another threshold,
an overall measured quality of the first link and the second link is lower than a threshold,
a measured quality of one of the first link and the second link is lower or higher than a measured quality of the other one of the first link and the second link by an offset, or
a measured quality of one of the first link and the second link is lower than a threshold by an offset dependent on a measured quality of the other one of the first link and the second link.

In an example, the first measurement report and/or the second measurement report can be transmitted when one or more of the following conditions are satisfied:
a measured quality of an end-to-end serving link is higher or lower than a threshold,
a measured interference of an end-to-end serving link is higher than a threshold
a measured quality of a non-serving link is higher than an end-to-end serving link or a threshold, or
a measured quality of an end-to-end serving link is lower than a threshold, while a measured quality of a non-serving link is higher than another threshold.

Here, the end-to-end serving link may include the first link, as a PC5 link, and the second link, as a Uu link, between the relay UE and the network node. The measured quality of the end-to-end serving link may be represented as a function of the first measurement result and/or second measurement result. Here, a quality of a link can be measured by one or more of RSRP, RSRQ, RSSI, SINR, SIR, or channel occupancy or channel busy ratio. The non-serving link may be a PC5 link, a Uu link, or an end-to-end link including a PC5 link and a Uu link.

For the end-to-end link between a remote UE and a gNB, the end-to-end link quality may be measured/evaluated by combining the measurement results for the PC5 link and the Uu link using a function (e.g. an averaged value). In order to compare the measurement results, additional offsets corresponding to differences of propagation distances and transmission power between different links may be considered. In this way, it is feasible to compare a serving end-to-end link with a neighboring link directly in terms of measured link quality.

In an example, the first measurement report and/or the second measurement report may include one or more of: one or more measurement identities, a measurement result for each of one or more serving frequencies, a measurement result for each of one or more inter-RAT or frequency links, an indication of the first link and/or the second link with which the first measurement result and/or the second measurement result is associated, a RAT or frequency with which the first measurement result and/or the second measurement result is associated, or an identifier of the first terminal device or the second terminal device (an identifier of the remote UE or the relay UE that generates the measurement report).

FIG. 10 is a flowchart illustrating a method 1000 according to an embodiment of the present disclosure. The method 1000 can be performed at a network node, e.g., a gNB.

At block 1010, a first measurement result for a first link between a first terminal device and a second terminal device and a second measurement result for a second link between the first terminal device and the network node is received from the first terminal device or the second terminal device.

Here, the first terminal device may be a remote UE, and the second terminal device may be a relay UE in an L2 or L3 UE-to-Network Relay configuration, or the first terminal device may be a relay UE, and the second terminal device may be a remote UE in an L2 or L3 UE-to-Network Relay configuration. The first link can be a serving or non-serving PC5 link, and the second link can be a serving or non-serving Uu link.

In an example, the first measurement result and the second measurement result may be received in a single measurement report or in separate measurement reports.

In an example, the network node can transmit, to the first terminal device and/or the second terminal device, a unified measurement configuration or separate measurement configurations for measuring the first link and/or the second link.

In an example, the unified measurement configuration, or each of the separate measurement configurations, may include one or more of: one or more measurement quantities, one or more measurement objects, one or more time and/or frequency resources to be measured, one or more measurement identities, one or more measurement gaps, or one or more measurement reporting configurations.

In an example, as described above in connection with the method 800 in FIG. 8, the one or more measurement quantities may include one or more of: RSRP, RSRQ, RSSI, SINR, SIR, or channel occupancy or channel busy ratio. At least one of the one or more measurement objects may be associated with one or more resource pools. The one or more resource pools may include an exceptional resource pool that is used only for measurement during a discovery procedure. The one or more time and/or frequency resources to be measured may be dependent on an RRC state of the first or second terminal device. The one or more measurement identities may include one or more of: a measurement identity assigned from a measurement identity pool used for non-discovery-related measurement, or a measurement identity assigned from a measurement identity pool used only for discovery-related measurement.

In an example, the unified measurement configuration, or each of the separate measurement configurations, may be transmitted via system information, RRC signaling, MAC CE, paging message, or L1 signaling (such as DCI).

In an embodiment, the network node can transmit, to the first terminal device and/or the second terminal device, an indication indicating which of the first terminal device and the second terminal device is to measure the first link or the second link, and/or which of the first terminal device and the second terminal device is to transmit the first measurement result and/or the second measurement result (e.g., which of the first terminal device and the second terminal device is to report the first measurement result and/or the second measurement result to the network node).

It is to be noted that the present disclosure is also applicable to L2 or L3 UE-to-UE Relay, in which case the first link and the second link may both be PC5 links. The remote UE and/or the relay UE can measure the PC5 links and transmit measurement results to a destination UE.

Correspondingly to the method 800 as described above, a first terminal device is provided. FIG. 11 is a block diagram of a first terminal device 1100 according to an embodiment of the present disclosure.

As shown in FIG. 11, the first terminal device 1100 includes an obtaining unit 1110 configured to obtain a first measurement result for a first link between the first terminal device and a second terminal device and/or a second measurement result for a second link between the first terminal device and a network node. The first terminal device 1100 further includes a transmitting unit 1120 configured to transmit the first measurement result and/or the second measurement result.

In an embodiment, the first measurement result and/or the second measurement result may be obtained by measuring the first link and/or the second link by the first terminal device, or receiving from the second terminal device the first measurement result and/or the second measurement result as obtained by measuring the first link and/or the second link by the second terminal device.

In an embodiment, the first measurement result and/or the second measurement result may be received via RRC signaling, MAC CE, or a control PDU.

In an embodiment, the first link and the second link may be measured in accordance with a unified measurement configuration or with separate measurement configurations.

In an embodiment, the unified measurement configuration, or each of the separate measurement configurations, may include one or more of: one or more measurement quantities, one or more measurement objects, one or more time and/or frequency resources to be measured, one or more measurement identities, one or more measurement gaps, or one or more measurement reporting configurations.

In an embodiment, the one or more measurement quantities may include one or more of: RSRP, RSRQ, RSSI, SINR, SIR, or channel occupancy or channel busy ratio.

In an embodiment, at least one of the one or more measurement objects may be associated with one or more resource pools.

In an embodiment, the one or more resource pools may include an exceptional resource pool that is used only for measurement during a discovery procedure.

In an embodiment, the one or more time and/or frequency resources to be measured may be dependent on an RRC state of the first or second terminal device.

In an embodiment, the one or more measurement identities may include one or more of: a measurement identity assigned from a measurement identity pool used for non-discovery-related measurement, or a measurement identity assigned from a measurement identity pool used only for discovery-related measurement.

In an embodiment, the first link and the second link may be measured in parallel or in a time-division manner.

In an embodiment, the unified measurement configuration, or each of the separate measurement configurations, may be preconfigured, or may be received from a network node, the second terminal device, or another terminal device controlling the first terminal device and the second terminal device, via system information, RRC signaling, MAC CE, paging message, or L1 signaling.

In an embodiment, the first link and/or the second link may be a non-serving link and the operation of measuring of the first link and/or the second link may be in response to: a radio quality of a current serving link being lower than a threshold, or a trigger from a network node, the second terminal device, or another terminal device controlling the first terminal device and the second terminal device, for the first or second terminal device to perform the measuring.

In an embodiment, the threshold may be higher than a radio quality threshold for triggering a relay reselection.

In an embodiment, the threshold may be dependent on an RRC state of the first or second terminal device.

In an embodiment, the first measurement result and/or the second measurement result may be transmitted to the second terminal device.

In an embodiment, the first measurement result and/or the second measurement result may be transmitted via RRC signaling, MAC CE, or a control PDU.

In an embodiment, the first terminal device may be a remote UE, and the second terminal device may be a relay UE in an L2 or L3 UE-to-Network Relay configuration.

In an embodiment, when the network node is a serving network node of the first terminal device, the second measurement result may be received from the second terminal device as a measurement result for a Uu link between the second terminal device and the network node.

In an embodiment, when the network node is a non-serving network node of the first terminal device, the second link may be measured by the first terminal device.

In an embodiment, the first measurement result may be transmitted in a first measurement report to the network node via the second terminal device, and/or the second measurement result may be transmitted in the first measurement report or a second measurement report to the network node via the second terminal device.

In an embodiment, the first measurement report and/or the second measurement report may be transmitted in a PC5-RRC message or a Uu RRC message.

In an embodiment, the first measurement report and the second measurement report may be included in separate information elements or containers.

In an embodiment, the first terminal device may be a relay UE, and the second terminal device is a remote UE in an L2 or L3 UE-to-Network Relay configuration.

In an embodiment, the first measurement result may be transmitted in a first measurement report to the network node, and/or the second measurement result may be transmitted in the first measurement report or a second measurement report to the network node.

In an embodiment, the first measurement report and/or the second measurement report may be transmitted in a Uu RRC message.

In an embodiment, the first measurement report and/or the second measurement report may be received from the second terminal device in a PC5-RRC message or a Uu RRC message.

In an embodiment, the first measurement report and/or the second measurement report may be transmitted periodically or when one or more of the following conditions are satisfied:
a measured quality of a serving Uu link is lower than a threshold, while a measured quality of a non-serving PC5 link is higher than another threshold,
a measured quality of a serving Uu link is lower than a threshold, while a measured quality of a non-serving Uu link is higher than another threshold,
a measured quality of any one of the first link and the second link is lower than a threshold,
a measured quality of one of the first link and the second link is lower than a threshold, while a measured quality of the other one of the first link and the second link is higher than another threshold,
a measured quality of the first link is lower than a threshold, while a measured quality of an inter-Radio Access Technology, RAT, or frequency link on which the first terminal device and the second terminal device are operating or capable of operating is higher than another threshold,
an overall measured quality of the first link and the second link is lower than a threshold,
a measured quality of one of the first link and the second link is lower or higher than a measured quality of the other one of the first link and the second link by an offset, or
a measured quality of one of the first link and the second link is lower than a threshold by an offset dependent on a measured quality of the other one of the first link and the second link.

In an embodiment, the first measurement report and/or the second measurement report may be transmitted when one or more of the following conditions are satisfied:
a measured quality of an end-to-end serving link is higher or lower than a threshold,
a measured interference of an end-to-end serving link is higher than a threshold
a measured quality of a non-serving link is higher than an end-to-end serving link or a threshold, or
a measured quality of an end-to-end serving link is lower than a threshold, while a measured quality of a non-serving link is higher than another threshold.

In an embodiment, the end-to-end serving link may include the first link, as a PC5 link, and the second link, as a Uu link, between the relay UE and the network node, and the measured quality of the end-to-end serving link may be represented as a function of the first measurement result and/or second measurement result, and/or the non-serving link may be a PC5 link, a Uu link, or an end-to-end link including a PC5 link and a Uu link.

In an embodiment, the first measurement report and/or the second measurement report may include one or more of: one or more measurement identities, a measurement result for each of one or more serving frequencies, a measurement result for each of one or more inter-RAT or frequency links, an indication of the first link and/or the second link with which the first measurement result and/or the second measurement result is associated, a RAT or frequency with which the first measurement result and/or the second measurement result is associated, or an identifier of the first terminal device or the second terminal device.

In an embodiment, the first link may be a serving or non-serving PC5 link, and the second link may be a serving or non-serving Uu link.

The units 1110 and 1120 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 8.

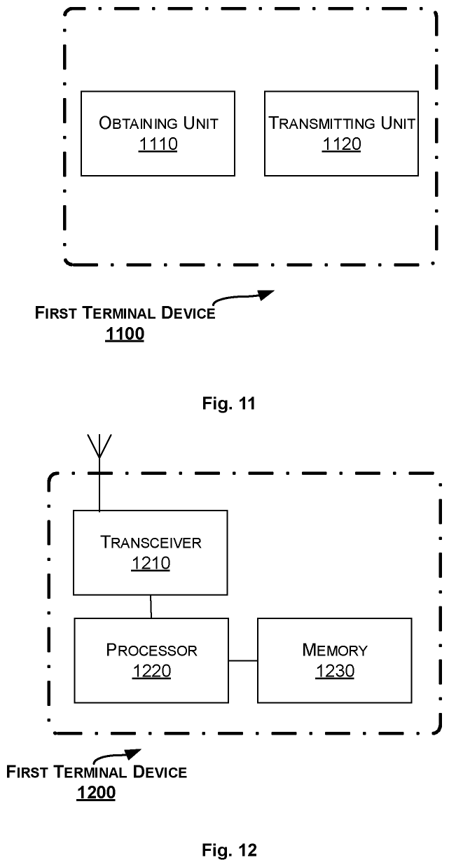

FIG. 12 is a block diagram of a first terminal device 1200 according to another embodiment of the present disclosure.

The first terminal device 1200 includes a transceiver 1210, a processor 1220 and a memory 1230. The memory 1230 may contain instructions executable by the processor 1220 whereby the first terminal device 1200 is operative to perform the actions, e.g., of the procedure described earlier in conjunction with FIG. 8. Particularly, the memory 1230 contains instructions executable by the processor 1220 whereby the first terminal device 1200 is operative to: obtain a first measurement result for a first link between the first terminal device and a second terminal device and/or a second measurement result for a second link between the first terminal device and a network node; and transmit the first measurement result and/or the second measurement result.

In an embodiment, the first measurement result and/or the second measurement result may be obtained by measuring the first link and/or the second link by the first terminal device, or receiving from the second terminal device the first measurement result and/or the second measurement result as obtained by measuring the first link and/or the second link by the second terminal device.

In an embodiment, the first measurement result and/or the second measurement result may be received via RRC signaling, MAC CE, or a control PDU.

In an embodiment, the first link and the second link may be measured in accordance with a unified measurement configuration or with separate measurement configurations.

In an embodiment, the unified measurement configuration, or each of the separate measurement configurations, may include one or more of: one or more measurement quantities, one or more measurement objects, one or more time and/or frequency resources to be measured, one or more measurement identities, one or more measurement gaps, or one or more measurement reporting configurations.

In an embodiment, the one or more measurement quantities may include one or more of: RSRP, RSRQ, RSSI, SINR, SIR, or channel occupancy or channel busy ratio.

In an embodiment, at least one of the one or more measurement objects may be associated with one or more resource pools.

In an embodiment, the one or more resource pools may include an exceptional resource pool that is used only for measurement during a discovery procedure.

In an embodiment, the one or more time and/or frequency resources to be measured may be dependent on an RRC state of the first or second terminal device.

In an embodiment, the one or more measurement identities may include one or more of: a measurement identity assigned from a measurement identity pool used for non-discovery-related measurement, or a measurement identity assigned from a measurement identity pool used only for discovery-related measurement.

In an embodiment, the first link and the second link may be measured in parallel or in a time-division manner.

In an embodiment, the unified measurement configuration, or each of the separate measurement configurations, may be preconfigured, or may be received from a network node, the second terminal device, or another terminal device controlling the first terminal device and the second terminal device, via system information, RRC signaling, MAC CE, paging message, or Layer 1 (L1) signaling.

In an embodiment, the first link and/or the second link may be a non-serving link and the operation of measuring of the first link and/or the second link may be in response to: a radio quality of a current serving link being lower than a threshold, or a trigger from a network node, the second terminal device, or another terminal device controlling the first terminal device and the second terminal device, for the first or second terminal device to perform the measuring.

In an embodiment, the threshold may be higher than a radio quality threshold for triggering a relay reselection.

In an embodiment, the threshold may be dependent on an RRC state of the first or second terminal device.

In an embodiment, the first measurement result and/or the second measurement result may be transmitted to the second terminal device.

In an embodiment, the first measurement result and/or the second measurement result may be transmitted via RRC signaling, MAC CE, or a control PDU.

In an embodiment, the first terminal device may be a remote UE, and the second terminal device may be a relay UE in an L2 or L3 UE-to-Network Relay configuration.

In an embodiment, when the network node is a serving network node of the first terminal device, the second measurement result may be received from the second terminal device as a measurement result for a Uu link between the second terminal device and the network node.

In an embodiment, when the network node is a non-serving network node of the first terminal device, the second link may be measured by the first terminal device.

In an embodiment, the first measurement result may be transmitted in a first measurement report to the network node via the second terminal device, and/or the second measurement result may be transmitted in the first measurement report or a second measurement report to the network node via the second terminal device.

In an embodiment, the first measurement report and/or the second measurement report may be transmitted in a PC5-RRC message or a Uu RRC message.

In an embodiment, the first measurement report and the second measurement report may be included in separate information elements or containers.

In an embodiment, the first terminal device may be a relay UE, and the second terminal device is a remote UE in an L2 or L3 UE-to-Network Relay configuration.

In an embodiment, the first measurement result may be transmitted in a first measurement report to the network node, and/or the second measurement result may be transmitted in the first measurement report or a second measurement report to the network node.

In an embodiment, the first measurement report and/or the second measurement report may be transmitted in a Uu RRC message.

In an embodiment, the first measurement report and/or the second measurement report may be received from the second terminal device in a PC5-RRC message or a Uu RRC message.

In an embodiment, the first measurement report and/or the second measurement report may be transmitted periodically or when one or more of the following conditions are satisfied:
a measured quality of a serving Uu link is lower than a threshold, while a measured quality of a non-serving PC5 link is higher than another threshold,
a measured quality of a serving Uu link is lower than a threshold, while a measured quality of a non-serving Uu link is higher than another threshold,
a measured quality of any one of the first link and the second link is lower than a threshold,
a measured quality of one of the first link and the second link is lower than a threshold, while a measured quality of the other one of the first link and the second link is higher than another threshold,
a measured quality of the first link is lower than a threshold, while a measured quality of an inter-Radio Access Technology, RAT, or frequency link on which the first terminal device and the second terminal device are operating or capable of operating is higher than another threshold,
an overall measured quality of the first link and the second link is lower than a threshold,
a measured quality of one of the first link and the second link is lower or higher than a measured quality of the other one of the first link and the second link by an offset, or
a measured quality of one of the first link and the second link is lower than a threshold by an offset dependent on a measured quality of the other one of the first link and the second link.

In an embodiment, the first measurement report and/or the second measurement report may be transmitted when one or more of the following conditions are satisfied:
a measured quality of an end-to-end serving link is higher or lower than a threshold,
a measured interference of an end-to-end serving link is higher than a threshold
a measured quality of a non-serving link is higher than an end-to-end serving link or a threshold, or
a measured quality of an end-to-end serving link is lower than a threshold, while a measured quality of a non-serving link is higher than another threshold.

In an embodiment, the end-to-end serving link may include the first link, as a PC5 link, and the second link, as a Uu link, between the relay UE and the network node, and the measured quality of the end-to-end serving link may be represented as a function of the first measurement result and/or second measurement result, and/or the non-serving link may be a PC5 link, a Uu link, or an end-to-end link including a PC5 link and a Uu link.

In an embodiment, the first measurement report and/or the second measurement report may include one or more of: one or more measurement identities, a measurement result for each of one or more serving frequencies, a measurement result for each of one or more inter-RAT or frequency links, an indication of the first link and/or the second link with which the first measurement result and/or the second measurement result is associated, a RAT or frequency with which the first measurement result and/or the second measurement result is associated, or an identifier of the first terminal device or the second terminal device.

In an embodiment, the first link may be a serving or non-serving PC5 link, and the second link may be a serving or non-serving Uu link.

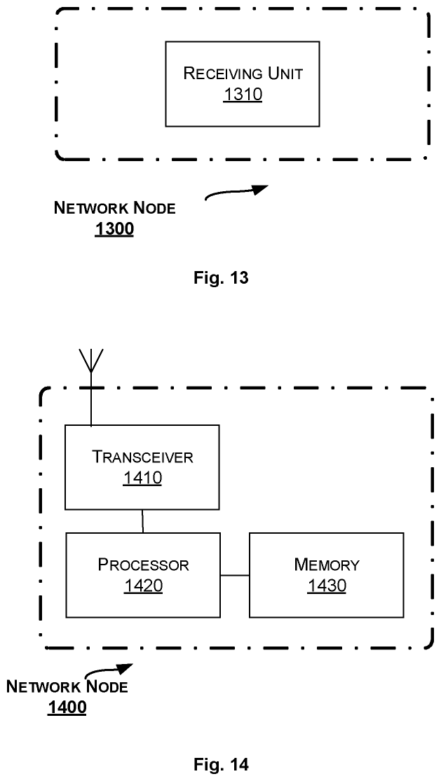

Correspondingly to the method 1000 as described above, a communication device is provided. FIG. 13 is a block diagram of a network node 1300 according to an embodiment of the present disclosure.

As shown in FIG. 13, the network node 1300 includes a receiving unit 1310 configured to receive, from a first terminal device or a second terminal device, a first measurement result for a first link between the first terminal device and the second terminal device and a second measurement result for a second link between the first terminal device and the network node.

In an embodiment, the first measurement result and the second measurement result may be received in a single measurement report or in separate measurement reports.

In an embodiment, the network node 1300 may further include a transmitting unit configured to transmit, to the first terminal device and/or the second terminal device, a unified measurement configuration or separate measurement configurations for measuring the first link and/or the second link.

In an embodiment, the unified measurement configuration, or each of the separate measurement configurations, may include one or more of: one or more measurement quantities, one or more measurement objects, one or more time and/or frequency resources to be measured, one or more measurement identities, one or more measurement gaps, or one or more measurement reporting configurations.

In an embodiment, the one or more measurement quantities may include one or more of: RSRP, RSRQ, RSSI, SINR, SIR, or channel occupancy or channel busy ratio.

In an embodiment, at least one of the one or more measurement objects may be associated with one or more resource pools.

In an embodiment, the one or more resource pools may include an exceptional resource pool that is used only for measurement during a discovery procedure.

In an embodiment, the one or more time and/or frequency resources to be measured may be dependent on an RRC state of the first or second terminal device.

In an embodiment, the one or more measurement identities may include one or more of: a measurement identity assigned from a measurement identity pool used for non-discovery-related measurement, or a measurement identity assigned from a measurement identity pool used only for discovery-related measurement.

In an embodiment, the unified measurement configuration, or each of the separate measurement configurations, may be transmitted via system information, RRC signaling, MAC CE, paging message, or L1 signaling.

In an embodiment, the network node 1300 may further include a transmitting unit configured to transmit, to the first terminal device and/or the second terminal device, an indication indicating which of the first terminal device and the second terminal device is to measure the first link or the second link, and/or which of the first terminal device and the second terminal device is to transmit the first measurement result and/or the second measurement result.

In an embodiment, the first terminal device may be a remote UE, and the second terminal device may be a relay UE in an L2 or L3 UE-to-Network Relay configuration, or the first terminal device may be a relay UE, and the second terminal device may be a remote UE in an L2 or L3 UE-to-Network Relay configuration.

The unit 1310 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 10.

FIG. 14 is a block diagram of a network node 1400 according to another embodiment of the present disclosure.

The network node 1400 includes a transceiver 1410, a processor 1420 and a memory 1430. The memory 1430 may contain instructions executable by the processor 1420 whereby the network node 1400 is operative to perform the actions, e.g., of the procedure described earlier in conjunction with FIG. 10. Particularly, the memory 1430 contains instructions executable by the processor 1420 whereby the network node 1400 is operative to: receive, from a first terminal device or a second terminal device, a first measurement result for a first link between the first terminal device and the second terminal device and a second measurement result for a second link between the first terminal device and the network node.

In an embodiment, the first measurement result and the second measurement result may be received in a single measurement report or in separate measurement reports.

In an embodiment, the memory 1430 may further contain instructions executable by the processor 1420 whereby the network node 1400 is operative to transmit, to the first terminal device and/or the second terminal device, a unified measurement configuration or separate measurement configurations for measuring the first link and/or the second link.

In an embodiment, the unified measurement configuration, or each of the separate measurement configurations, may include one or more of: one or more measurement quantities, one or more measurement objects, one or more time and/or frequency resources to be measured, one or more measurement identities, one or more measurement gaps, or one or more measurement reporting configurations.

In an embodiment, the one or more measurement quantities may include one or more of: RSRP, RSRQ, RSSI, SINR, SIR, or channel occupancy or channel busy ratio.

In an embodiment, at least one of the one or more measurement objects may be associated with one or more resource pools.

In an embodiment, the one or more resource pools may include an exceptional resource pool that is used only for measurement during a discovery procedure.

In an embodiment, the one or more time and/or frequency resources to be measured may be dependent on an RRC state of the first or second terminal device.

In an embodiment, the one or more measurement identities may include one or more of: a measurement identity assigned from a measurement identity pool used for non-discovery-related measurement, or a measurement identity assigned from a measurement identity pool used only for discovery-related measurement.

In an embodiment, the unified measurement configuration, or each of the separate measurement configurations, may be transmitted via system information, RRC signaling, MAC CE, paging message, or L1 signaling.

In an embodiment, the memory 1430 may further contain instructions executable by the processor 1420 whereby the network node 1400 is operative to transmit, to the first terminal device and/or the second terminal device, an indication indicating which of the first terminal device and the second terminal device is to measure the first link or the second link, and/or which of the first terminal device and the second terminal device is to transmit the first measurement result and/or the second measurement result.

In an embodiment, the first terminal device may be a remote UE, and the second terminal device may be a relay UE in an L2 or L3 UE-to-Network Relay configuration, or the first terminal device may be a relay UE, and the second terminal device may be a remote UE in an L2 or L3 UE-to-Network Relay configuration.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 1220 causes the first terminal device 1200 to perform the actions, e.g., of the procedure described earlier in conjunction with FIG. 8; or code/computer readable instructions, which when executed by the processor 1420 causes the network node 1400 to perform the actions, e.g., of the procedure described earlier in conjunction with FIG. 10.

The computer program product may be configured as a computer program code structured in computer program modules. The computer program modules could essentially perform the actions of the flow illustrated in FIG. 8 or 10.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-Access Memory (RAM), a Read-Only Memory (ROM), or an EEPROM, and the computer program modules described above could in alternative embodiments be distributed on different computer program products in the form of memories.

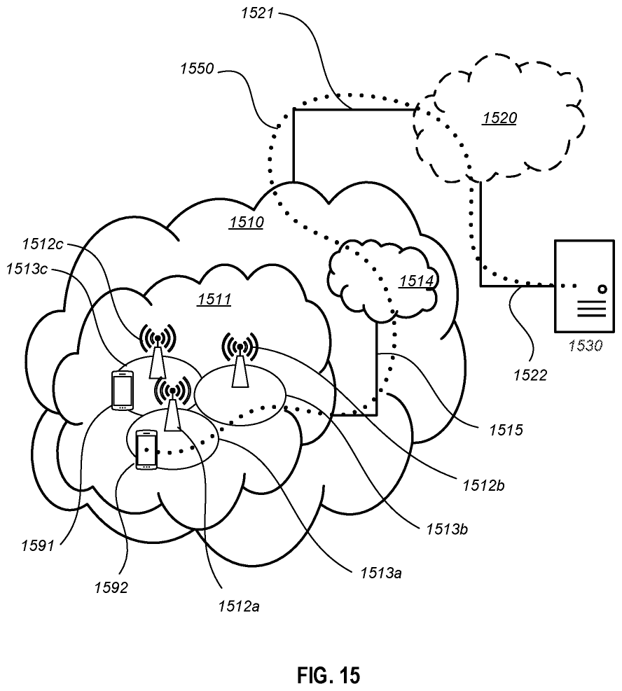

With reference to FIG. 15, in accordance with an embodiment, a communication system includes a telecommunication network 1510, such as a 3GPP-type cellular network, which comprises an access network 1511, such as a radio access network, and a core network 1514. The access network 1511 comprises a plurality of base stations 1512a, 1512b, 1512c, such as NBs, eNBs, gNBs or other types of wireless access points, each defining a corresponding coverage area 1513a, 1513b, 1513c. Each base station 1512a, 1512b, 1512c is connectable to the core network 1514 over a wired or wireless connection 1515. A first user equipment (UE) 1591 located in coverage area 1513c is configured to wirelessly connect to, or be paged by, the corresponding base station 1512c. A second UE 1592 in coverage area 1513a is wirelessly connectable to the corresponding base station 1512a. While a plurality of UEs 1591, 1592 are illustrated in this example, the disclosed embodiments are equally applicable to a situation where a sole UE is in the coverage area or where a sole UE is connecting to the corresponding base station 1512.

The telecommunication network 1510 is itself connected to a host computer 1530, which may be embodied in the hardware and/or software of a standalone server, a cloud-implemented server, a distributed server or as processing resources in a server farm. The host computer 1530 may be under the ownership or control of a service provider, or may be operated by the service provider or on behalf of the service provider. The connections 1521, 1522 between the telecommunication network 1510 and the host computer 1530 may extend directly from the core network 1514 to the host computer 1530 or may go via an optional intermediate network 1520. The intermediate network 1520 may be one of, or a combination of more than one of, a public, private or hosted network; the intermediate network 1520, if any, may be a backbone network or the Internet; in particular, the intermediate network 1520 may comprise two or more sub-networks (not shown).

The communication system of FIG. 15 as a whole enables connectivity between one of the connected UEs 1591, 1592 and the host computer 1530. The connectivity may be described as an over-the-top (OTT) connection 1550. The host computer 1530 and the connected UEs 1591, 1592 are configured to communicate data and/or signaling via the OTT connection 1550, using the access network 1511, the core network 1514, any intermediate network 1520 and possible further infrastructure (not shown) as intermediaries. The OTT connection 1550 may be transparent in the sense that the participating communication devices through which the OTT connection 1550 passes are unaware of routing of uplink and downlink communications. For example, a base station 1512 may not or need not be informed about the past routing of an incoming downlink communication with data originating from a host computer 1530 to be forwarded (e.g., handed over) to a connected UE 1591. Similarly, the base station 1512 need not be aware of the future routing of an outgoing uplink communication originating from the UE 1591 towards the host computer 1530.

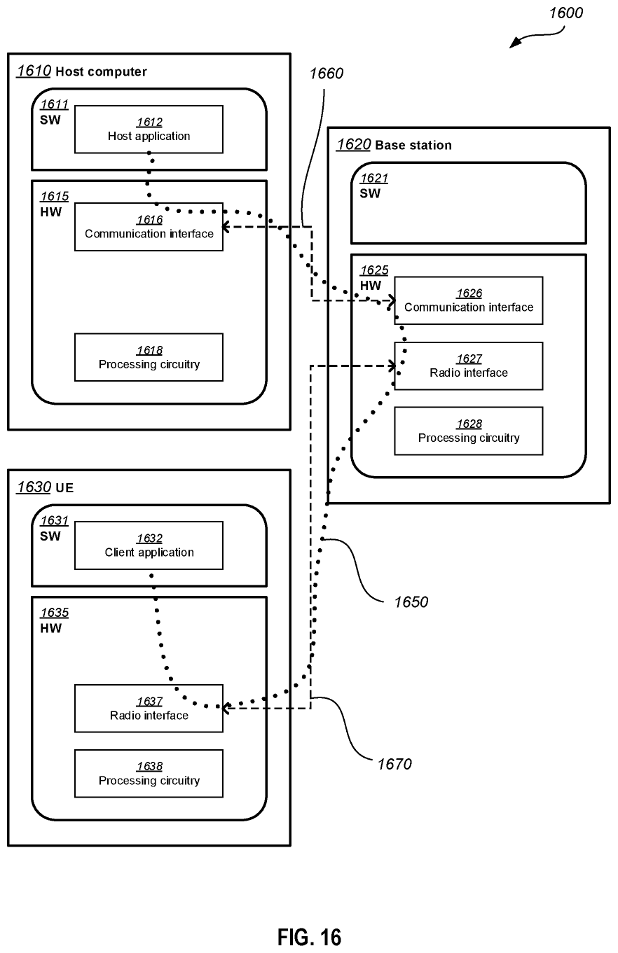

Example implementations, in accordance with an embodiment, of the UE, base station and host computer discussed in the preceding paragraphs will now be described with reference to FIG. 16. In a communication system 1600, a host computer 1610 comprises hardware 1615 including a communication interface 1616 configured to set up and maintain a wired or wireless connection with an interface of a different communication device of the communication system 1600. The host computer 1610 further comprises processing circuitry 1618, which may have storage and/or processing capabilities. In particular, the processing circuitry 1618 may comprise one or more programmable processors, application-specific integrated circuits, field programmable gate arrays or combinations of these (not shown) adapted to execute instructions. The host computer 1610 further comprises software 1611, which is stored in or accessible by the host computer 1610 and executable by the processing circuitry 1618. The software 1611 includes a host application 1612. The host application 1612 may be operable to provide a service to a remote user, such as a UE 1630 connecting via an OTT connection 1650 terminating at the UE 1630 and the host computer 1610. In providing the service to the remote user, the host application 1612 may provide user data which is transmitted using the OTT connection 1650.

The communication system 1600 further includes a base station 1620 provided in a telecommunication system and comprising hardware 1625 enabling it to communicate with the host computer 1610 and with the UE 1630. The hardware 1625 may include a communication interface 1626 for setting up and maintaining a wired or wireless connection with an interface of a different communication device of the communication system 1600, as well as a radio interface 1627 for setting up and maintaining at least a wireless connection 1670 with a UE 1630 located in a coverage area (not shown in FIG. 16) served by the base station 1620. The communication interface 1626 may be configured to facilitate a connection 1660 to the host computer 1610. The connection 1660 may be direct or it may pass through a core network (not shown in FIG. 16) of the telecommunication system and/or through one or more intermediate networks outside the telecommunication system. In the embodiment shown, the hardware 1625 of the base station 1620 further includes processing circuitry 1628, which may comprise one or more programmable processors, application-specific integrated circuits, field programmable gate arrays or combinations of these (not shown) adapted to execute instructions. The base station 1620 further has software 1621 stored internally or accessible via an external connection.

The communication system 1600 further includes the UE 1630 already referred to. Its hardware 1635 may include a radio interface 1637 configured to set up and maintain a wireless connection 1670 with a base station serving a coverage area in which the UE 1630 is currently located. The hardware 1635 of the UE 1630 further includes processing circuitry 1638, which may comprise one or more programmable processors, application-specific integrated circuits, field programmable gate arrays or combinations of these (not shown) adapted to execute instructions. The UE 1630 further comprises software 1631, which is stored in or accessible by the UE 1630 and executable by the processing circuitry 1638. The software 1631 includes a client application 1632. The client application 1632 may be operable to provide a service to a human or non-human user via the UE 1630, with the support of the host computer 1610. In the host computer 1610, an executing host application 1612 may communicate with the executing client application 1632 via the OTT connection 1650 terminating at the UE 1630 and the host computer 1610. In providing the service to the user, the client application 1632 may receive request data from the host application 1612 and provide user data in response to the request data. The OTT connection 1650 may transfer both the request data and the user data. The client application 1632 may interact with the user to generate the user data that it provides.

It is noted that the host computer 1610, base station 1620 and UE 1630 illustrated in FIG. 16 may be identical to the host computer 1530, one of the base stations 1512a, 1512b, 1512c and one of the UEs 1591, 1592 of FIG. 15, respectively. This is to say, the inner workings of these entities may be as shown in FIG. 16 and independently, the surrounding network topology may be that of FIG. 15.

In FIG. 16, the OTT connection 1650 has been drawn abstractly to illustrate the communication between the host computer 1610 and the use equipment 1630 via the base station 1620, without explicit reference to any intermediary devices and the precise routing of messages via these devices. Network infrastructure may determine the routing, which it may be configured to hide from the UE 1630 or from the service provider operating the host computer 1610, or both. While the OTT connection 1650 is active, the network infrastructure may further take decisions by which it dynamically changes the routing (e.g., on the basis of load balancing consideration or reconfiguration of the network).

The wireless connection 1670 between the UE 1630 and the base station 1620 is in accordance with the teachings of the embodiments described throughout this disclosure. One or more of the various embodiments improve the performance of OTT services provided to the UE 1630 using the OTT connection 1650, in which the wireless connection 1670 forms the last segment. More precisely, the teachings of these embodiments may improve the data rate and thereby provide benefits such as reduced user waiting time.

A measurement procedure may be provided for the purpose of monitoring data rate, latency and other factors on which the one or more embodiments improve. There may further be an optional network functionality for reconfiguring the OTT connection 1650 between the host computer 1610 and UE 1630, in response to variations in the measurement results. The measurement procedure and/or the network functionality for reconfiguring the OTT connection 1650 may be implemented in the software 1611 of the host computer 1610 or in the software 1631 of the UE 1630, or both. In embodiments, sensors (not shown) may be deployed in or in association with communication devices through which the OTT connection 1650 passes; the sensors may participate in the measurement procedure by supplying values of the monitored quantities exemplified above, or supplying values of other physical quantities from which software 1611, 1631 may compute or estimate the monitored quantities. The reconfiguring of the OTT connection 1650 may include message format, retransmission settings, preferred routing etc.; the reconfiguring need not affect the base station 1620, and it may be unknown or imperceptible to the base station 1620. Such procedures and functionalities may be known and practiced in the art. In certain embodiments, measurements may involve proprietary UE signaling facilitating the host computer's 1610 measurements of throughput, propagation times, latency and the like. The measurements may be implemented in that the software 1611, 1631 causes messages to be transmitted, in particular empty or ‘dummy’ messages, using the OTT connection 1650 while it monitors propagation times, errors etc.

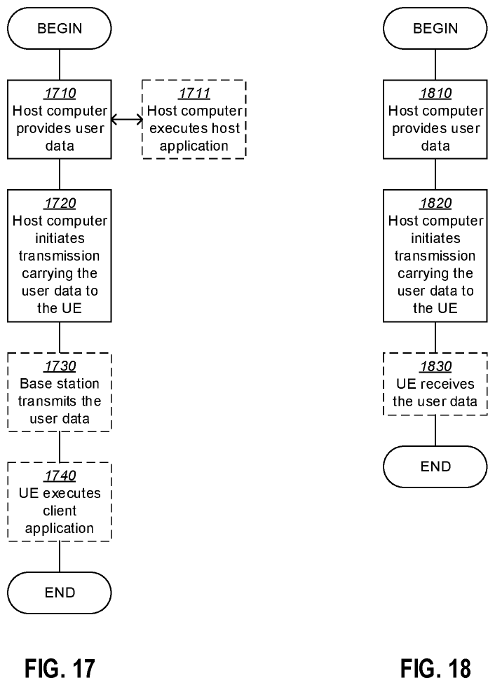

FIG. 17 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 17 will be included in this section. In a first step 1710 of the method, the host computer provides user data. In an optional substep 1711 of the first step 1710, the host computer provides the user data by executing a host application. In a second step 1720, the host computer initiates a transmission carrying the user data to the UE. In an optional third step 1730, the base station transmits to the UE the user data which was carried in the transmission that the host computer initiated, in accordance with the teachings of the embodiments described throughout this disclosure. In an optional fourth step 1740, the UE executes a client application associated with the host application executed by the host computer.

FIG. 18 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 18 will be included in this section. In a first step 1810 of the method, the host computer provides user data. In an optional substep (not shown) the host computer provides the user data by executing a host application. In a second step 1820, the host computer initiates a transmission carrying the user data to the UE. The transmission may pass via the base station, in accordance with the teachings of the embodiments described throughout this disclosure. In an optional third step 1830, the UE receives the user data carried in the transmission.

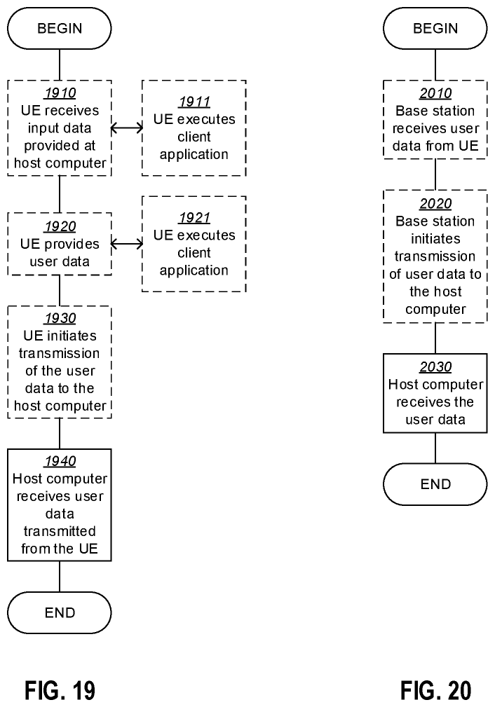

FIG. 19 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 19 will be included in this section. In an optional first step 1910 of the method, the UE receives input data provided by the host computer. Additionally or alternatively, in an optional second step 1920, the UE provides user data. In an optional substep 1921 of the second step 1920, the UE provides the user data by executing a client application. In a further optional substep 1911 of the first step 1910, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1930, transmission of the user data to the host computer. In a fourth step 1940 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 20 will be included in this section. In an optional first step 2010 of the method, in accordance with the teachings of the embodiments described throughout this disclosure, the base station receives user data from the UE. In an optional second step 2020, the base station initiates transmission of the received user data to the host computer. In a third step 2030, the host computer receives the user data carried in the transmission initiated by the base station.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

The present disclosure further includes the following embodiments.

The present disclosure refers to the NR RAT but can be applied also to LTE RAT and any other RAT enabling the direct transmission between two (or more) nearby devices without any loss of meaning.

Further, we refer to remote (RM) UE as the remote UE that needs to transmit/receive packets from/to the gNB or another UE (called target remote UE) via an intermediate mobile terminal (relay) that we refer to as relay (RL) UE.

The following embodiments can be applied on both the L2 and L3 relay architectures.

Further, in all the embodiments the receiver of the measurement results is a gNB (i.e., in case of UE-to-NW architecture) but it can also be another UE (destination remote UE in case of UE-to-UE architecture). In addition, in both UE to NW architecture and UE to UE architecture, PC5 link measurement results of a UE may also send to another UE if necessary, thereafter in this case, the another UE will be also a receiver of the measurement results.

Further, in the following we consider a relay path that comprises a first path (between the remote UE and the relay UE) and a second relay path that is between the relay UE and the gNB or destination remote UE (depending if we consider UE-to-NW or UE-to-UE relay) that hereafter we refer to “destination node”.

Also, the measured PC5 interfaces of a UE contain at least one of the below:
serving PC5 links that the UE has already established, which may contain at least unicast links,
neighbor UEs which have no unicast PC5 links established towards the UE yet,
any PC5 interface of the UE which is involved with group cast or broadcast transmissions.

The measured Uu links/cells of a UE contain at least one of the below:
serving cells belonging to the same or different gNBs, neighbor cells belonging to the same or different gNBs.

The measured PC5 interfaces or Uu links/cells may be deployed with a same RAT or different RATs, at same or different frequency bands.

Specifically for an end-to-end (E2E) link between a source RM UE and a destination node (e.g., gNB or a destination RM UE), its E2E link quality may be measured/evaluated by combining measurement results on each hop using such as a function (e.g. an averaged value of the per hop measurements). In order to compare per hop measurements, additional offsets corresponding to differences of propagation distances and transmission powers between different hops may be considered. In this way, it is feasible to compare a serving E2E link with a neighbor link directly in terms of measured link quality.

In the first embodiment, a UE (i.e., RM UE or RL UE) is configured/preconfigured with at least one measurement configuration for measurements on Uu links/cells and PC5 links/interfaces.

The measurement configuration may contain one or multiple of the below parameters for example
Measurement quantities (e.g., RSRP, RSRQ, RSSI, SINR, SIR, channel occupancy/busy ratio etc)
   One single quantity or combination of multiple quantities
One or multiple measurement objects
   Each measurement object may be associated to one or multiple specific resource pools.
      e.g., an exceptional resource pool to be used only for the purpose of performing measurements during discovery.
   Resource pools may belong to the same frequency band or different frequency bands
The PC5 frequencies that need to be measured. The configuration may be different for UE in different RRC states, e.g. different number of PC5 frequencies may need to be measured when the UE is in different RRC states.
One or multiple measurement report configurations
   one configuration may be associated to a specific measurement event-based report pattern
   one configuration may be associated to a periodic measurement report pattern
One or multiple measurement identities
   The measurement identity(ies) may be assigned from the same measurement identities pool that is used when the UE perform measurements not related to discovery.
   The measurement identity(ies) may be assigned from a measurement identities pool that is only used for discovery purposes.

Note: some of the above parameters are applicable to measurements on both Uu links/cells and PC5 interfaces/links. While some other above parameters are only applicable to measurements on Uu links/cells or PC5 interfaces/links.

The UE performs measurements on Uu links and PC5 links/interfaces accordingly.

In the second embodiment, the UE (i.e., RM UE or RL UE) is configured at least two separate measurement configurations for measurements on Uu links/cells and PC5 links/interfaces separately. For instance, one configuration is associated with a PC5 RRC Connection between the RM UE and the RL UE, and another configuration is associated with a Uu RRC connection between the RM UE and a serving gNB. In case the UE has multiple established PC5 RRC Connections, the UE is configured with a separate measurement configuration for every PC5 RRC connection.

In the third embodiment, the UE (i.e., RM UE or RL UE) is configured with a unified measurement configuration for measurements on Uu links and PC5 links/interfaces, i.e., a same configuration containing measurement settings for both Uu links and PC5 links. This measurement configuration may be associated with a RRC Connection (i.e., either Uu RRC connection or PC5 RRC connection).

In the fourth embodiment, according to measurement configurations, the UE (i.e., RM UE or RL UE) measures Uu links and PC5 links/interfaces in parallel or at different time slots. For the former, the UE may support multiple connections (e.g., one direction connection to a serving gNB, and one indirect connection to a serving gNB via a relay UE, or one direct connection to another neighbor UE). In order to support parallel measurements, the UE may be configured with separate RF chains for different connections. For the latter, the UE may be configured with a shared RF chain between multiple connections. The UE switches between Uu and PC5 links at different slots. At any given time slot, the UE only measures one connection. Measurement gaps or switch pattern in time domain between connections may be configured accordingly.

In the fifth embodiment, the remote UE doesn't have direct Uu connection to its serving gNB, in this case, the remote UE cannot measure its serving Uu link. Therefore, the remote UE can use the relay UE's measurement results on the serving Uu link. So, the relay UE needs to forward its measurements on the serving Uu link to the remote UE via at least one of the below signaling alternatives
RRC signaling (e.g., PC5-RRC)
MAC CE
Control PDU of a protocol layer such as SDAP, PDCP, RLC, or an adaptation layer

In the sixth embodiment, the UE (i.e., RM UE or RL UE) formulates measurement reports and sends to the receivers. The UE may apply at least one of the below options to build measurement reports.

Option 1: the UE builds a separate measurement report containing measurement results for Uu links/cells and PC5 interfaces/links separately. This option may be applicable in case the UE has different measurement configurations for Uu links/cells and PC5 interfaces/links respectively.

Option 2: the UE builds a combined measurement report containing measurement results for both Uu links/cells and PC5 interfaces/links (i.e., cross connection/RAT measurement report). This option may be applicable in case the UE has a unified measurement configuration for both Uu links/cells and PC5 interfaces/links. Alternatively, regardless if the UE is configured with a unified measurement configuration for both Uu links/cells and PC5 interfaces/links, the UE anyway formulates a combined measurement report containing measurement results for both Uu links/cells and PC5 interfaces/links. The UE may be configured/preconfigured with a parameter indicating whether the UE is allowed to build a cross connection/RAT measurement report. The UE may also be configured/preconfigured with how to formulate a combined measurement report containing measurement results for both Uu links/cells and PC5 interfaces/links.

For any of the above option, in a measurement report, the UE (i.e., RM UE or RL UE) explicitly indicates whether a reported measurement result is a measurement on Uu link or a measurement on sidelink. Alternatively, no explicit indicator is added but instead a mapping between Uu link quality and sidelink link quality is (pre) configured, the UE adjusts the Uu measurement results or the sidelink measurement results according to the mapping and then puts the adjusted measurement results in the measurement report. It may also be (pre)configured whether the Uu measurement results or the sidelink measurement results should be adjusted.

In the seventh embodiment, in case both the RM UE and the RL UE are configured with measurement configurations, both UEs may measure the same links (i.e., PC5 interfaces/links, or Uu links/cells). Given that
1) Both UEs may measure a same PC5 link (i.e., measurement based on received signals which are transmitted at different directions). The measurement results would be similar or equal.
2) Both UEs may measure a same cell. However, since both UEs are located in a same proximity area, measurements on the same cell would be also similar or equal.

Therefore, it is feasible to reduce or avoid overlapping measurement efforts. It may be sufficient to share measurement results on the same links between both UEs. It will be beneficial to reduce power consumption for both UEs. For specific links, it is configured/preconfigured to allow only RM UE or RL UE to measure. After measurements, measurement results shared between both UEs. The measurement results of a UE can be shared to another UE using at least one of the below signaling alternatives:
RRC signaling (e.g., PC5-RRC),
MAC CE,
Control PDU of a protocol layer such as SDAP, PDCP, RLC, or an adaptation layer.

In addition, in case multiple RM UEs connecting to the same RL UE, or a RM UE connecting to multiple RL UEs, similar mechanisms are applicable.

In the eighth embodiment, a UE (e.g., the RM UE or the RL UE) involved in a sidelink relay transmission sends a measurement report to the receivers that comprises at least measurement results on the serving links (i.e., the first relay hop and the second relay hop). The first relay hop is a PC5 link whereas the second relay hop can be a PC5 link (if destination node is a UE) or a Uu link (if destination node is a gNB). Given that
1) both the RM UE and the RL UE can measure the first hop (i.e., the RM UE measures signals transmitted from the RL UE to RM UE, while the RL UE measures signals transmitted from the RM UE to RL UE). Their measurements would be similar or equal.
2) both the RM UE and the RL UE may share same measurement results on the second hop (i.e., the RM UE cannot measure the second hop by itself) To avoid redundant reporting on the serving link (including the first hop and the second hop), when reporting the measurement results to the receivers (e.g., destination node), the following options can be applied:

Option 1. The remote and relay UE reports the measurement results independently. This basically means that the remote UE reports the measurements for the first relay hop to the relay UE and that the relay UE reports the measurements results to the destination node. The relay UE may choose to not measure the first hop by itself. When reporting the measurement results to the destination node, the relay UE has the following alternatives:
a. The relay UE reports the measurements results for the first relay hop and the second relay hop in the same Uu RRC message but in separate information elements or containers (OCTET STRING). In this case, the destination node will be able to distinguish which measurements results belong to the first relay hop and which measurement results belong to the second relay hop.
b. The relay UE calculates a value/reports/structure as a function (e.g. the average or the sum) of the measurements results for the first and second relay hop and provides this value/report/structure to the destination node. In such a way, the destination node will not distinguish if the value/reports/structure is for measurements results belong to which relay hop, but it has just an overall estimate on what is the channel quality of the first and second relay hop, i.e., E2E link quality.

Option 2. The remote UE reports measurement results for the first relay hop to the destination node via the relay UE and the relay UE reports the measurement results for the second relay hop to the destination node. The RL UE may choose to not measure the first hop by itself. In this case, if the second relay hop is operating on Uu/PC5, the remote UE includes the measurements results for the first relay hop in a Uu/PC5 RRC message and the relay UE will simply forward this Uu/PC5 RRC message without decoding it. Once the destination node receives both measurement results for the first and second relay hop it just combine them to take some decision.

Option 3. The relay UE reports the measurement results for the second relay hop to the remote UE and the remote UE reports the measurement results for the first and second hop to the destination node. The RL UE may choose to not measure the first hop by itself. In such a case, since the first relay hop is operating over PC5, the relay UE sends the measurement results of the second relay hop in a PC5 RRC message and send this PC5 RRC message to the remote UE. Once receiving such measurement results from the relay UE, the remote UE reports the combined measurement results for the first and second relay hop to the destination node according to the alternatives described in Option 1.

In a sub-embodiment, it is preconfigured or configured by the NW or the controlling UE which option should be used to report the measurement results. Different options may be configured for different UEs and/or different RRC states.

In the ninth embodiment, a UE (i.e., the RM UE or the RL UE) sends a measurement report to the destination node when one (or more) of the following criteria (referred to as “events” in the measurement configuration terminology) are fulfilled for example:
The measured serving Uu quality is below one threshold while the best measured neighbor sidelink quality exceeds another threshold.
The measured serving sidelink quality is below one threshold while the best measured neighbor Uu quality exceeds another threshold.
The link quality of the second relay hop become worse than a threshold and the link quality of the first hop become better than a threshold
The link quality on the first relay hop become worse than a threshold and the link quality on the second relay hop become better than a threshold
The serving link quality on the first relay hop becomes worse than a threshold and inter-RAT/frequency link quality on the RAT/frequency in which also the first relay hop is operating or is capable to operate (e.g., PC5) becomes better than a threshold.
A combined (e.g. the average) link quality over the first and second relay hop becomes worse than a threshold.
The link quality over the first/second relay hop becomes offset better than the link quality over the second/first relay hop.
The link quality over the first relay hop+an offset (where the offset is dependant from the signal strength over the second relay hop) becomes worse than a threshold. The dependence may be predefined or configured by the NW.
The link quality over the second relay hop+an offset (where the offset is dependant from the link quality over the first relay hop) becomes worse than a threshold. The dependence may be predefined or configured by the NW.
The UE may report the measurements results periodically, if configured to do so.
The UE may report the measurements results when the signal strength over the first relay hop is below of a given threshold.

As another embodiment, the UE may check whether E2E serving link quality fulfils at least one or multiple of the below conditions/events. A neighbor link may be a Uu link or a PC5 interface/link, or another E2E link containing multiple hops.
E2E serving link becomes better than threshold
E2E serving link becomes worse than threshold
Neighbor link becomes offset better than E2E serving link
Neighbor link becomes better than threshold
E2E serving link becomes worse than threshold1 and neighbor link becomes better than threshold2
Inter RAT neighbor link becomes better than threshold
E2E serving link becomes worse than threshold1 and inter RAT neighbor becomes better than threshold2
Interference of E2E serving link becomes higher than threshold

Alternatively, the UE uses the first link quality to represent E2E serving link quality, and checks if it fulfils at least one or multiple of the above conditions/events. Alternatively, for U2N relay, the UE uses the second link quality to represent E2E serving link quality, and checks if it fulfils at least one or multiple of the above conditions/events.

Alternatively, the UE uses any one of the below measurement quantities to evaluate the link quality of E2E link/neighbor link/any hop link, and further checks if the measurements fulfil at least one or multiple of the above conditions/events.
Measurement quantities (e.g., RSRP, RSRQ, RSSI, SINR, SIR, channel occupancy/busy ratio etc)
   One single quantity or combination of multiple quantities

In the tenth embodiment, the measurement reports for the first or second relay hop may comprise one (or more) of the following information:
Measurement ID (or a list of)
A single (or a list of) measurement result for a single serving frequency
A single (or a list of) measurement result for one or more inter-RAT/frequencies
The relay hop (first or second) to which the measurement results belong to.
The RAT/frequency to which the measurement results belong.
The ID of the UE that has created the measurement reports (if the measurement reports have been received and relayed by another UE e.g., relay UE or remote UE).

In the eleventh embodiment, the RM UE may only trigger measurements on neighbor UEs/links or other RAT/frequencies where SL relay is allowed when the radio quality of current serving link is below a (pre)configured threshold. This threshold may be different from the one used to trigger the relay path reselection. In other words, this threshold may be used to trigger early measurements so that the UE can perform measurements on neighbor links or the other RAT/frequencies before the serving link becomes too bad. Furthermore, different thresholds may be (pre)configured for RM UE in different RRC states, e.g. a higher threshold for RM UE in RRC CONNECTED.

In the twelfth embodiment, the RM UE triggers measurements on neighbor UEs/links or other RAT/frequencies where SL relay is allowed only when the UE has received a signaling indicating that the UE is allowed or requested to do so. This signaling may be received from a network node such as gNB or another UE. Further, the way how the RM UE receives such signal may be according to what is described in fifth embodiment.

In the thirteenth embodiment, for a neighbor UE, the RM UE may not measure the PC5 link between the RM UE and the neighbor UE, instead, the RM UE may request the neighbor UE to provide it an info containing measurement results which the neighbor UE has measured on the reverse link. In this way, the RM UE can reduce its power consumption by reducing the measurement efforts on certain neighbor links.

In the fourteenth embodiment, the first relay hop is operating over PC5 (sidelink) RAT and the second relay hop is operating over Uu RAT and vice versa.

In the fifteenth embodiment, for any of the above embodiment, measurement configurations are configured to the UE by a network node such as gNB or a UE (e.g., a controlling UE, or a relay UE) via at least one of the below signaling alternative:
system information,
RRC signaling,
MAC CE,
Paging message,
L1 signaling such as DCI, or SCI,
Pre-configured (hard-coded) in the specification.

In addition, a network node such as gNB or a controlling UE includes the measurement configurations for the remote UE in the RRC message sent to the relay UE ((as separate IEs or within a container), the relay UE then forwards the measurement configurations to the remote UE using PC5-RRC. In case the container is used, the relay UE can simply put the container in its PC5-RRC without decoding it.

1.-46. (canceled)

47. A method in a first terminal device, comprising:
obtaining a first measurement result for a first link between the first terminal device and a second terminal device and a second measurement result for a second link between the first terminal device and a network node; and
transmitting the first measurement result and the second measurement result to the network node;
wherein the first measurement result is obtained by receiving from the second terminal device, and the second measurement result is obtained by measuring the second link;
wherein the first link and the second link are measured in accordance with separate measurement configurations.

48. The method of claim 47, wherein each of the separate measurement configurations, comprises one or more of:
one or more measurement quantities,
one or more measurement objects,
one or more time and/or frequency resources to be measured,
one or more measurement identities,
one or more measurement gaps, or
one or more measurement reporting configurations.

49. The method of claim 48, wherein at least one of the one or more measurement objects is associated with one or more resource pools.

50. The method of claim 49, wherein the one or more resource pools comprise an exceptional resource pool that is used only for measurement during a discovery procedure.

51. The method of claim 48, wherein the one or more measurement identities comprise one or more of:
a measurement identity assigned from a measurement identity pool used for non-discovery-related measurement, or
a measurement identity assigned from a measurement identity pool used only for discovery-related measurement.

52. The method of claim 47, wherein the first link and/or the second link is a non-serving link and said measuring of the first link and/or the second link is in response to:
a radio quality of a current serving link being lower than a threshold, or
a trigger from a network node, the second terminal device, or another terminal device controlling the first terminal device and the second terminal device, for the first or second terminal device to perform the measuring.

53. The method of claim 52, wherein the threshold is higher than a radio quality threshold for triggering a relay reselection.

54. The method of claim 47, wherein the first terminal device is a relay User Equipment, UE, and the second terminal device is a remote UE in a Layer 2, L2, or Layer 3, L3, UE-to-Network Relay configuration.

55. The method of claim 54, wherein the first measurement result and the second measurement result are transmitted in a Uu RRC message, wherein the first measurement result and the second measurement result are transmitted in a single or separate report.

56. The method of claim 55, wherein the first measurement report and/or the second measurement result are transmitted periodically, or when one or more of the following conditions are satisfied:
a measured quality of a serving Uu link is lower than a threshold, while a measured quality of a non-serving PC5 link is higher than another threshold,
a measured quality of a serving Uu link is lower than a threshold, while a measured quality of a non-serving Uu link is higher than another threshold,
a measured quality of any one of the first link and the second link is lower than a threshold,
a measured quality of one of the first link and the second link is lower than a threshold, while a measured quality of the other one of the first link and the second link is higher than another threshold,
a measured quality of the first link is lower than a threshold, while a measured quality of an inter-Radio Access Technology, RAT, or frequency link on which the first terminal device and the second terminal device are operating or capable of operating is higher than another threshold,
an overall measured quality of the first link and the second link is lower than a threshold,
a measured quality of one of the first link and the second link is lower or higher than a measured quality of the other one of the first link and the second link by an offset, or
a measured quality of one of the first link and the second link is lower than a threshold by an offset dependent on a measured quality of the other one of the first link and the second link.

57. The method of claim 55, wherein the single or separate measurement reports comprise one or more of:
one or more measurement identities,
a measurement result for each of one or more serving frequencies,
a measurement result for each of one or more inter-RAT or frequency links,
an indication of the first link and/or the second link with which the first measurement result and/or the second measurement result is associated,
a RAT or frequency with which the first measurement result and/or the second measurement result is associated, or
an identifier of the first terminal device or the second terminal device.

58. A first terminal device, comprising a transceiver, a processor and a memory, the memory comprising instructions executable by the processor whereby the first terminal device is operative to perform the method according to claim 47.

59. A method in a network node, comprising:
transmitting, separate measurement configurations for measuring a first link between a first terminal device and a second terminal device, and a second link between the first terminal device and the network node;
receiving, from the first terminal device, a first measurement result for the first link and a second measurement result for the second link, wherein the first measurement result and the second measurement result are received in a single measurement report or in separate measurement reports.

60. The method of claim 59, wherein each of the separate measurement configurations, comprises one or more of:
one or more measurement quantities,
one or more measurement objects,
one or more time and/or frequency resources to be measured,
one or more measurement identities,
one or more measurement gaps, or
one or more measurement reporting configurations;
wherein at least one of the one or more measurement objects is associated with one or more resource pools, and/or
wherein the one or more measurement identities comprise one or more of:
a measurement identity assigned from a measurement identity pool used for non-discovery-related measurement, or
a measurement identity assigned from a measurement identity pool used only for discovery-related measurement.

61. The method of claim 59, wherein the first terminal device is a relay UE, and the second terminal device is a remote UE in an L2 or L3 UE-to-Network Relay configuration, and
wherein the first measurement report and/or the second measurement result are received periodically, or when one or more of the following conditions are satisfied:
a measured quality of a serving Uu link is lower than a threshold, while a measured quality of a non-serving PC5 link is higher than another threshold,
a measured quality of a serving Uu link is lower than a threshold, while a measured quality of a non-serving Uu link is higher than another threshold,
a measured quality of any one of the first link and the second link is lower than a threshold,
a measured quality of one of the first link and the second link is lower than a threshold, while a measured quality of the other one of the first link and the second link is higher than another threshold,
a measured quality of the first link is lower than a threshold, while a measured quality of an inter-Radio Access Technology, RAT, or frequency link on which the first terminal device and the second terminal device are operating or capable of operating is higher than another threshold,
an overall measured quality of the first link and the second link is lower than a threshold,
a measured quality of one of the first link and the second link is lower or higher than a measured quality of the other one of the first link and the second link by an offset, or
a measured quality of one of the first link and the second link is lower than a threshold by an offset dependent on a measured quality of the other one of the first link and the second link.

62. A network node, comprising a transceiver, a processor and a memory, the memory comprising instructions executable by the processor whereby the network node is operative to perform the method according to claim 59.
